(19) United States
(12) Patent Application Publication
(10) Pub. No.: US 2014/0213333 A1
(43) Pub. Date: Jul. 31, 2014

(54) Puzzle-Based Interaction System For Eliciting A Desired Behavior

(71) Applicant: Puzzling Commerce, LLC, West Chester, PA (US)

(72) Inventors: Matthew Scott Hanes, West Chester, PA (US); Robert Brinson, Rome, GA (US); Scott Cottle, Raleigh, NC (US)

(21) Appl. No.: 14/165,842

(22) Filed: Jan. 28, 2014

Related U.S. Application Data
(60) Provisional application No. 61/757,951, filed on Jan. 29, 2013.

(51) Int. Cl. A63F 13/00

(52) U.S. Cl. CPC A63F 13/005
USPC 463/9

(57) ABSTRACT

A method of operating a server including receiving a request from an electronic device for access by a user to a puzzle, and retrieving a profile for the user and conditions for access to the puzzle. If the user is authorized access then the puzzle is sent to the electronic device for display to the user. A user input regarding a puzzle piece is received and verified. If the input is valid with respect to that puzzle piece then the appearance of the display or that puzzle piece is changed. If inputs for a predetermined number of puzzle pieces or a predetermined set of puzzle pieces have been verified, then the display on the electronic device indicates that a goal has been reached.

### CROSS-REFERENCE TO RELATED APPLICATION

This application claims the priority of U.S. Provisional Patent Application No. 61/757,951, filed Jan. 29, 2013, entitled “Puzzle-Based Consumer Interaction System,” the entire disclosure and contents of which are hereby incorporated by reference herein.

### SUMMARY

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

A method of operating a server is disclosed. The method includes receiving a request from an electronic device for access by a user to a puzzle, retrieving a profile for the user or preferences of the user, and retrieving conditions for access to the puzzle. If the user is authorized to have access to the puzzle based upon the profile or preferences of the user and the conditions for access, then sending the puzzle to the electronic device for display to the user. If a request is received from the electronic device to verify an input regarding a puzzle piece then verifying the validity of the input with respect to that puzzle piece. If the input is valid with respect to that puzzle piece then causing the appearance of the display to be changed or causing the appearance of that puzzle piece to be changed. If inputs for a predetermined number of puzzle pieces have been verified or inputs for a predetermined set of puzzle pieces have been verified, then instructing the electronic device to indicate that a goal has been reached or recording that a goal has been reached.

A method of operating a personal electronic device is also disclosed. The method includes displaying a puzzle, accepting an input regarding a piece of the plurality of pieces, and verifying the validity of the input with respect to that piece. If the input is valid with respect to that piece, then changing the appearance of the display or changing the appearance of that piece. If inputs for a predetermined number of pieces have been verified or inputs for a predetermined set of pieces have been verified, then indicating that a goal has been reached, recording that a goal has been reached, transmitting a signal indicating that a goal has been reached, or displaying a reward.

The puzzle has a plurality of pieces, the display has an appearance, and each piece has an appearance.

### BRIEF DESCRIPTION OF THE DRAWINGS

FIG. 1 is an illustration of an exemplary environment and an exemplary system diagram for a puzzle-based interaction system;

FIG. 2 is a flow diagram showing one illustrative routine for a puzzle-based interaction system;

FIG. 3 is a flow diagram showing another illustrative routine for a puzzle-based interaction system;

FIG. 4 is a diagram illustrating some of the functions and features performed by the process and/or logic modules;

FIGS. 5-31 illustrate various exemplary screen displays;

FIG. 32 is a computer architecture diagram showing an illustrative computer architecture; and

FIG. 33 is a block diagram showing aspects of an exemplary revenue distribution plan.

### DETAILED DESCRIPTION

The following detailed description is directed to technologies for a puzzle-based interaction system which elicits a desired behavior. For example, the desired behavior may be for a student or a patron to see certain exhibits in a gallery or a museum, or for a visitor to see certain significant buildings or historical sites in the city or in an area, or for patrons and potential patrons to purchase certain items or services or to patronize certain vendors. While one can certainly hand a person of a list of things to see or do, the non-exciting nature of a list itself might even cause the person to avoid those things. The puzzle-based interaction described herein, however, makes such participation engaging, interesting and enjoyable, thereby eliciting and encouraging the desired behavior. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like. In the following detailed description, references may be made to the accompanying drawings that form a part hereof, and which are shown by way of illustration specific embodiments or examples. Referring now more specifically to the drawings, in which like numerals represent like elements throughout the several figures, aspects of a computing system, computer-readable storage medium, and computer-implemented methodology for puzzle-based interaction will be presented.

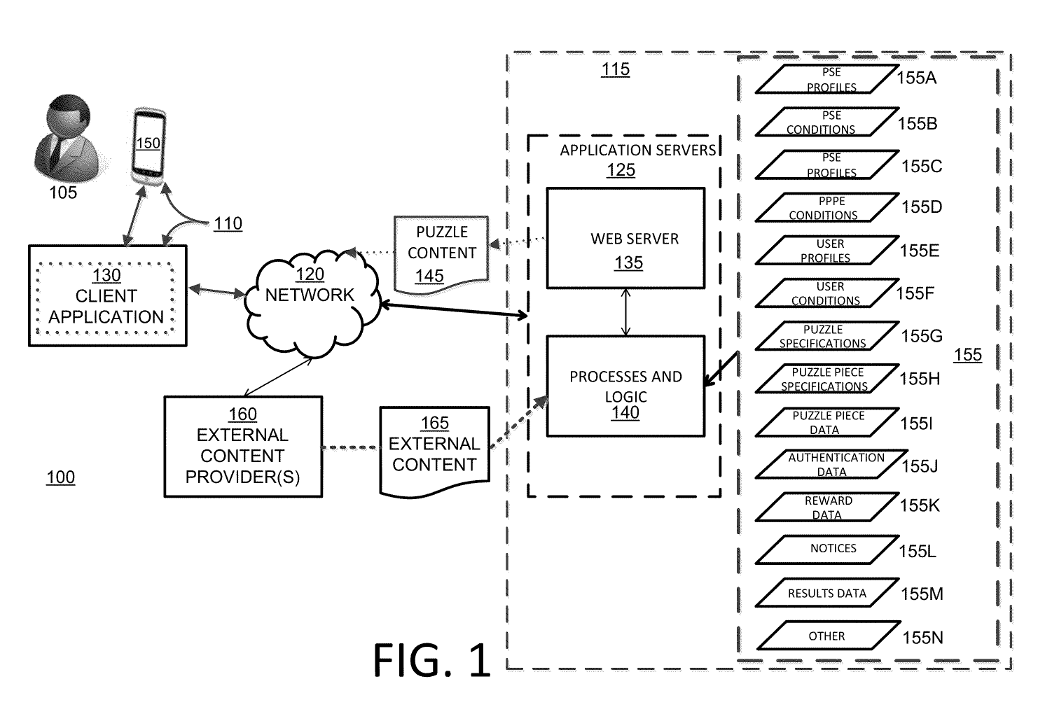

FIG. 1 is an illustration of an exemplary environment and system diagram for a puzzle-based interaction system. The exemplary system shown provides a suitable computing environment for performing the various operations disclosed herein. The exemplary operating environment 100 includes at least one user 105 who uses a user device 110 to access puzzles provided by a system 115. The user device 110 may be any type of personal electronic device, such as, but not limited to, a personal computer (“PC”), a desktop workstation, a laptop, a notebook, a personal digital assistant (“PDA”), a smart phone or cellphone, an electronic-book reader, a game console, a set-top box, a consumer electronics device, a device provided by a sponsor, an establishment, or a business, a server computer, or any other computing device capable of connecting to the network 120 and communicating with the system 115.

The network 120 may be a local-area network (“LAN”), a wide-area network (“WAN”), the Internet, or any other networking topology or combination of networking topologies known in the art that connects the user device 110 to the system 115. The system 115 may include a number of application servers 125 that provide various application services to the user device 110 over the network 120. The user 105 may use a client application 130 executing on the user device 110 to access and utilize the application services provided by the application servers 125. According to one embodiment, the client application 130 may be a mobile application residing on a smartphone. The mobile application exchanges data with a web server 135 executing on the application servers 125 or other computing resources in the system 115 using a data transfer protocol over the network 120. Alternatively, the client application 130 may utilize any number of communication methods known in the art to communicate with the system 115 and/or the application servers 125 across the network 120, including remote procedure calls, SOAP-based web services, remote file access, proprietary client-server architectures, and the like.

The application servers 125 may execute a number of process and logic modules 140 in order to provide the application services to the client application 110. The logic modules 140 may execute on a single application server 125 or in parallel across multiple application servers 125 in the system 115. In addition, each process and/or logic module 140 may consist of a number of subcomponents executing on different application servers 125 or other computing devices in the system 115. The modules may be implemented as software, hardware, firmware, or a combination thereof.

According to one embodiment, one or more process and/or logic modules 140 provide puzzle content 145 to the user 105 (via the user's device 110) based on user-supplied profile data, contest/game data, etc., as is described in detail above. The process and/or logic modules 140 may generate the puzzle content 145 based on various data available to the application servers 125 in system 115. For example, the process and/or logic modules 140 may correlate Notices (notifications, advisories, hints, advertisements, etc.) 155L to puzzle piece provider entity (“PPPE”) conditions 155D utilizing the methods and/or algorithms described herein to generate the puzzle content 145. The Notices 155L and PPPE conditions 155D may be stored in a database or other data storage mechanism in the system 115 and accessible by the application servers 125. In another embodiment, the Puzzle piece data 1551 data may be accessed dynamically from other third-party servers over the Internet or some other network in a near real-time basis.

Similarly, the process and/or logic modules 140 may utilize puzzle sponsor entity (“PSE”) profiles 155A, PSE conditions 155B, PSE profiles 155C, PPPE conditions 155D, User profiles 155E, User conditions 155F, Puzzle specifications 155G, Puzzle piece specifications 155H, Puzzle piece data 1551, Authentication data 155J, Reward data 155K, Notices 155L, Results data 155M, and/or other data and information 155N in providing content to the user 105 (via the user's device 110) in or in conjunction with the puzzle content 145.

The puzzle content 145 and other information generated by the process and/or logic modules 140 may be transmitted by the web server 135 over the network 120 to the client application 130 for display to the user 105. The puzzle content 145 may be a delivered in a mobile app on a smartphone consisting of hypertext markup language (“HTML”), extensible markup language (“XML”), JavaScript object notation (“JSON”), text, a file of executable code, or other data type that contains the puzzle content and other information, possibly along with, for example, instructions regarding how the puzzle content is to be rendered by the client application 130.

The client application 130 may receive the puzzle content 145 and other information from the web server 135 and display the information to the user on a display 150 connected to or part of the user device 110. In addition, the client application 130 may allow the user 105 to provide user input and interact with the display of information using one or more input devices connected to or part of the user device 110. Input devices may be, for example, a touchscreen, a keyboard, a key pad, a mouse, a joystick, etc. The web server 135 may encode the puzzle content 145 and other information and send the information to the client application 130 for decoding (if encoded) the ad display to the user 105. Any desired and appropriate method may be used for encoding/decoding, and transmission of the information between the web server 135 and the user device 110.

According to a further embodiment, the process and/or logic modules 140 may retrieve external content 165, such as advertising, push messages, news, and the like, via the network 120 from external content provider(s) 160 such as, but not limited to, a local listings provider. It will be appreciated that such content could also be provided internally from contributors through the system 115. Any internal content and the external content 165 may then be localized and filtered based on other data specified in user profiles 155E or user conditions 155F, etc., and provided to the user 105 by the web server 135 along with the puzzle content 145 and other information.

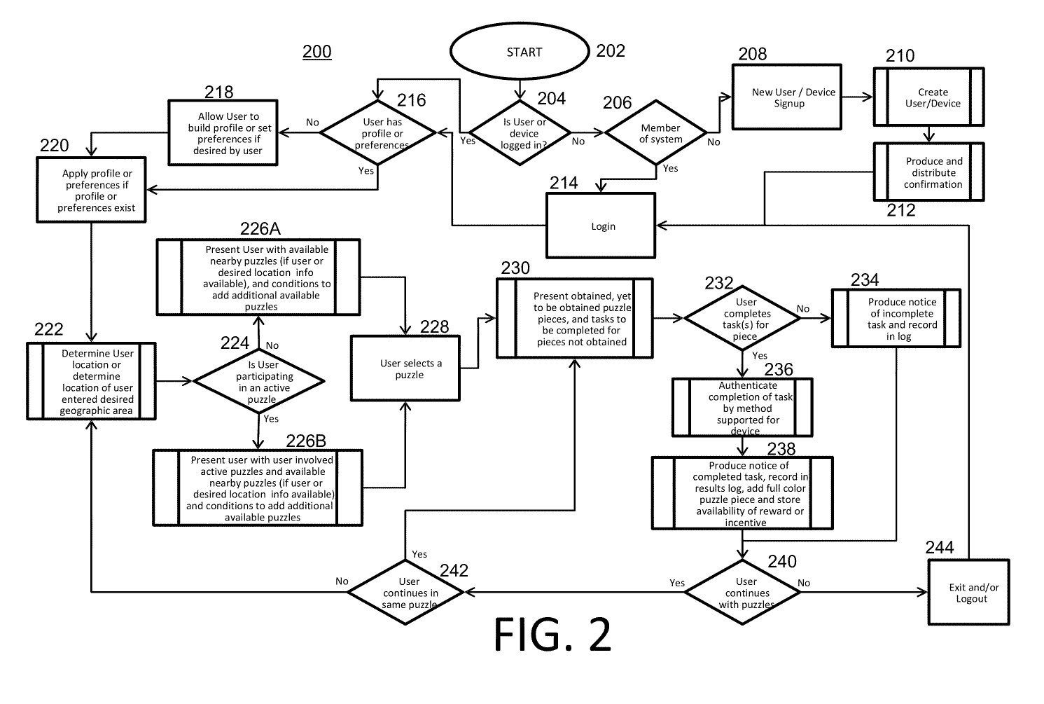

FIG. 2 is a flow diagram showing one illustrative routine 200 for a puzzle-based interaction system. It may be performed by way of an application configured for execution on, for example, a mobile device, or that is presented by way of a non-mobile device, or executed by a server and presented through a Web browser. The logical operations of the various implementations shown in FIG. 2 and the other figures may be implemented (1) as a sequence of computer implemented acts or program modules running on a computing system and/or (2) as interconnected machine logic circuits or circuit modules.

The particular implementation may depend on the performance requirements of the application and the performance capabilities of the user's device 110 and/or the system 115. The logical operations making up the implementations described herein may be referred to variously as operations, steps, structural devices, acts or modules. These operations, steps, structural devices, acts and modules may be implemented in software, in firmware, in special purpose digital logic, and any combination thereof.

The flow diagram provides a logic flow detailing the functions and features, preferably performed by the process and/or logic modules 140 described above, but some of which may also be performed by the device 110, to provide the application services to the user 105. Upon starting 202, it is determined 204 whether the user or device is logged in to the system 115. If so, then step 216 is executed. If not then it is determined 206 whether the user or device is a member of the particular system, club, program, promotion, tour, etc. If so then step 214 is executed where the user or device may login, and then step 216 is executed. If not then step 208 is executed where a new user may sign up and/or a new device may be registered. A user/device profile is then created 210. A confirmation of the signup and information is then generated and distributed 212. Then step 214 is executed.

Login may be by any desired method, such as but not limited to a user name, a user password, a PIN value, an image selection, etc. If the user has not established 216 a profile and/or preferences then the user is allowed 218 to build a profile and/or set preferences as desired and then step 220 is executed. If not, the step 220 is executed. The user profile and/or preferences are then applied 220.

The user profile and/or preferences may be utilized to determine the particular puzzles and tasks which may be presented to a particular user. For example, the age of the user, the religious or personal beliefs or the user, the medical history and condition of the user, etc., may indicate that puzzles, puzzle pieces, tasks, rewards, etc., involving, for example, tobacco, alcohol, meat products, pork products, firearms, sexually explicit material, etc., should not be presented to that user.

The location of the user, or that the user is entering a geographic area, is then determined 222. A determination is then made 224 whether the user is participating in an active puzzle. If not then the user is presented 226A with available puzzles and any conditions which must be fulfilled to add additional available puzzles. The availability of puzzles may be determined, for example, based on the location of the user, the profile of the user, the preferences of the user, the preferences of the PPPE, etc. If so at 224, then the user is presented 226B with active puzzles and possibly also with available puzzles as mentioned above. Upon the completion of either step 226A or step 226B step 288 is executed whereby the user is allowed to select a desired puzzle, which may be either a new puzzle or an existing puzzle.

In step 230 the puzzle pieces are presented (displayed) to the user. The puzzle pieces include previously-obtained puzzle pieces, puzzle pieces which have yet to be obtained, and tasks to be completed in order to obtain one or more puzzle pieces. Step 232 tests whether the user has completed the task or tasks specified by a puzzle piece, or a selected puzzle piece if it is required that the puzzle piece has previously selected in order to obtain credit for a particular task having been completed on a particular device. If not, then step 234 is executed wherein a notice is produced and recorded that the task or tasks has not yet been completed and then step 240 is executed. If so then step 236 authenticates that the particular task or tasks has been properly completed, step 238 is executed wherein a notice is produced and recorded that the task(s) specified for a particular puzzle piece have been completed, and the availability of a reward or incentive are stored. Furthermore, preferably, the appearance of that particular puzzle piece is changed, such as by changing the color, transparency, opacity, shading, visual aspect, or physical attribute, adding full color, displaying the reward or incentive, etc. Step 240 is then executed. A reward may be, for example, the availability of another puzzle, a free or reduced price product or service, appearing in a ranking of contestants, a monetary award if permitted by local law, etc.

Step 240 is then executed which asks the user whether the user wishes to continue with puzzles. If not then step 244 is executed wherein the user logs out. If so then step 242 is executed which asks the user whether the user wishes to continue in the same puzzle. If so then step 230 is executed. If not then step 222 is executed.

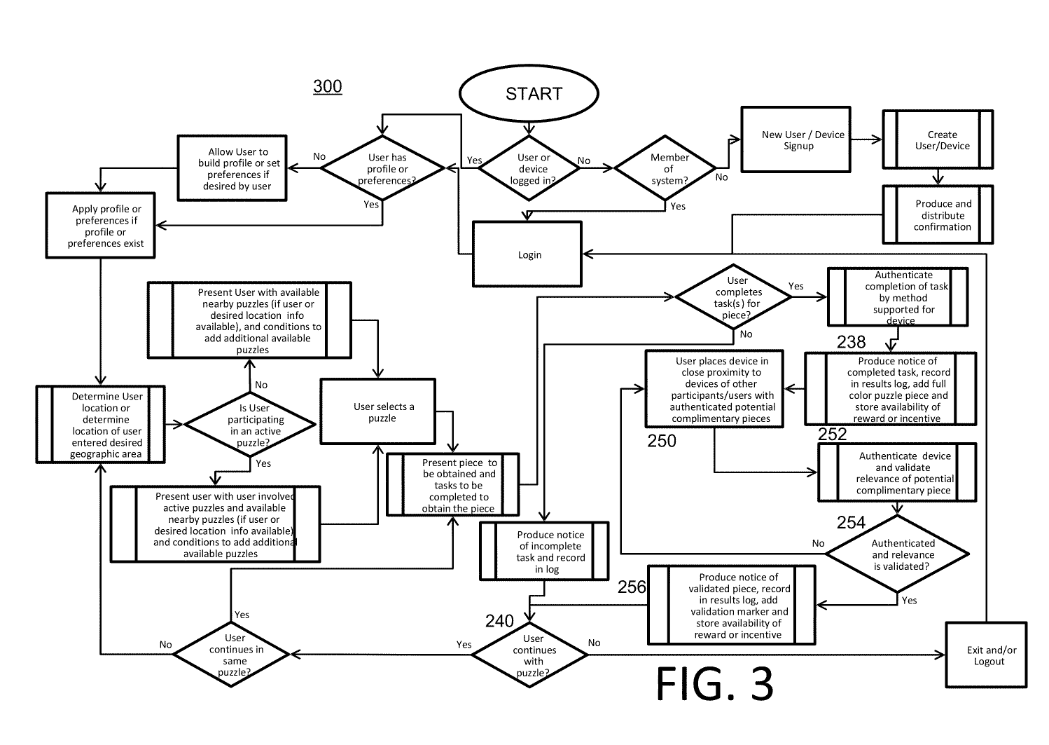

FIG. 3 is a flow diagram showing another illustrative routine 300 for a puzzle-based interaction system. The routine 300 is similar in operation to the operation of routine 200 but has some additional steps which provide additional features. After step 238 has been completed, the user searches out and/or mingles with other users and places 250 his/her device 110 in close proximity to, or in contact with, a device 110 of another user. Whether two devices 110 are in close proximity may be determined by any desired or convenient technique such as, but not limited to, for example, one device evaluating the strength of a signal received from the other device. The devices 110 may then exchange information regarding authentication of the pieces of a selected puzzle or puzzles. If the device 110 of one user has a piece which is complementary to a piece on the device 110 of the other user, or if the one device 110 has a piece which is needed by the other device 110, then the device needing that piece(s) may obtain the authentication information for that piece(s) from the first device 100. In step 252 the device 110 obtaining the authentication information for that piece(s) sends the authentication information to the system 115 for validation and relevance. In step 254 the system 115 determines whether the authentication information is valid and relevant. If the authentication information is valid, and the piece(s) is relevant to the puzzle(s) on that user's device, then in step 256 a notice is produced and recorded that the particular puzzle piece has been validated, and the availability of a reward or incentive are stored. Step 240 is then executed and the process continues as in FIG. 2. Thus, teams can be formed which can share the accomplishment and validation of tasks and puzzle pieces. Also, users having complementary or compatible profiles may be able to identify each other.

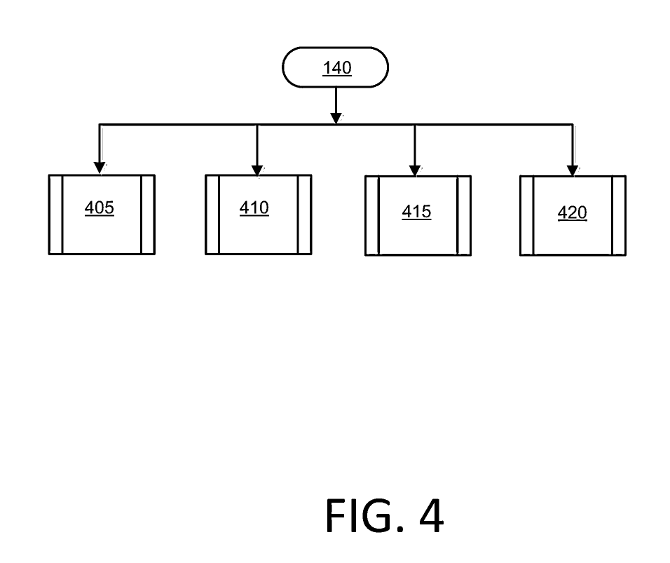

FIG. 4 is a diagram illustrating some of the functions and features performed by the process and/or logic modules 140 for administration of the system 115. These functions include puzzle creation 405, reward and incentive management 410, PSE management 415, PPPE management 420, and the like.

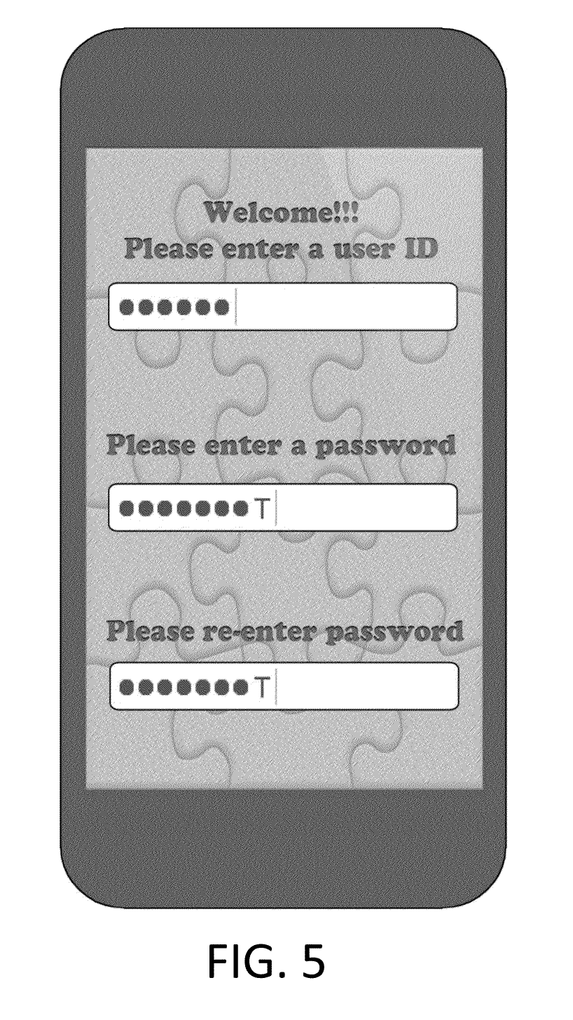

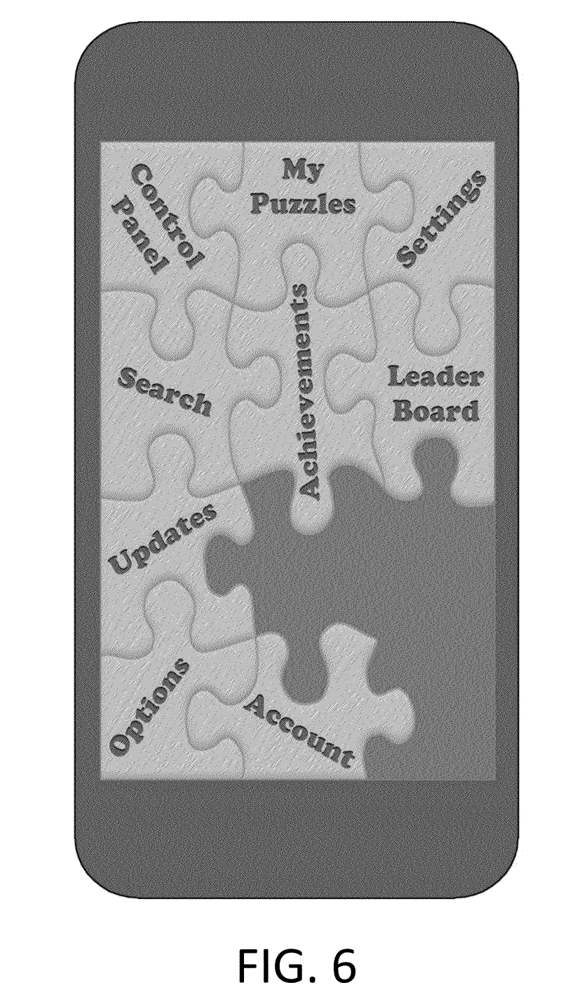

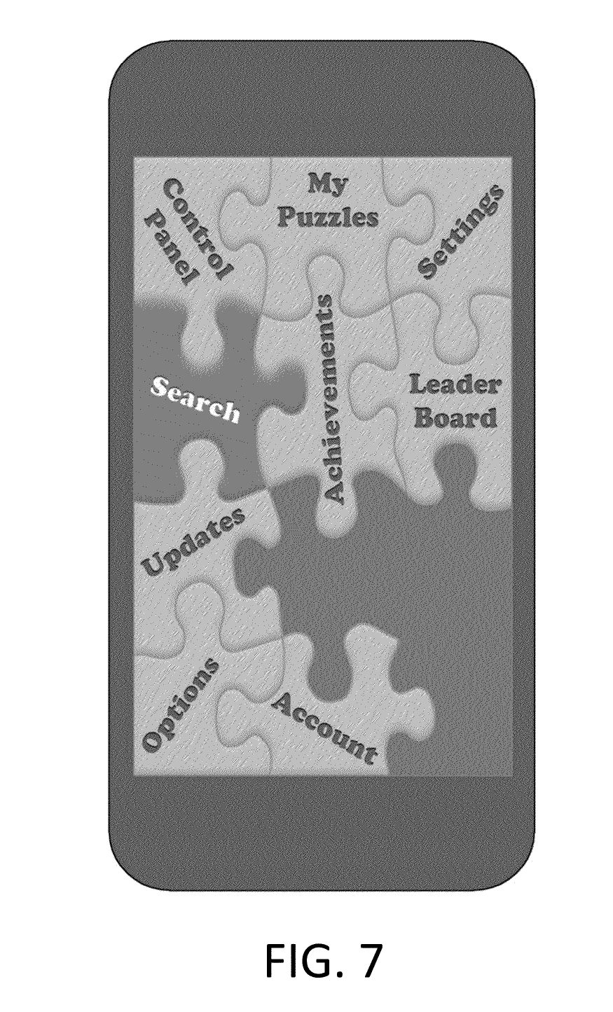

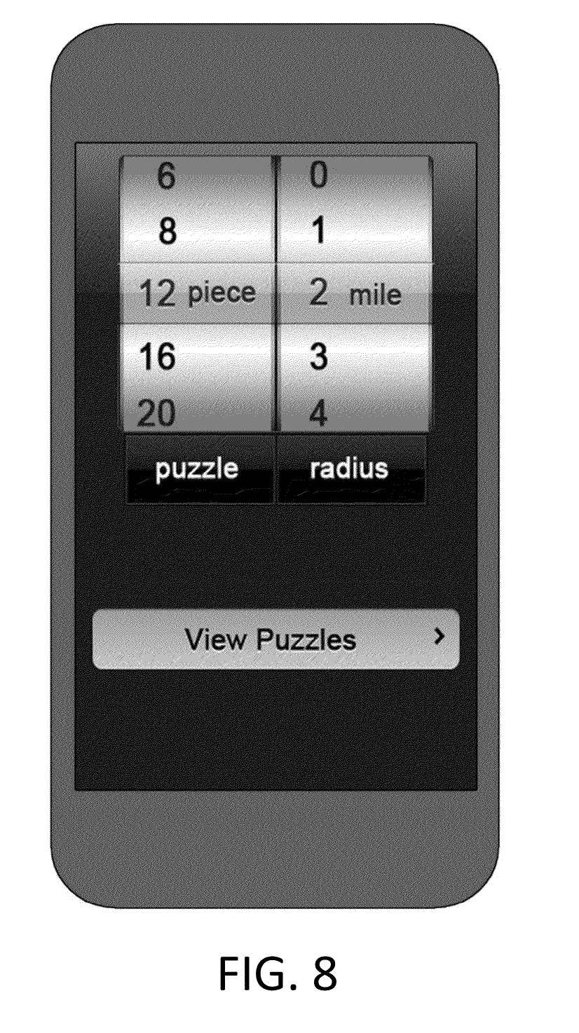

FIGS. 5-31 illustrate various exemplary screen displays, such as may be presented on the user's device 110 by, for example, a mobile application or by a server 125 via a web browser. In particular, an exemplary smartphone user interface is shown wherein the user logs in. FIG. 6 shows an exemplary user interface where the user is presented with a home screen menu or page. FIG. 7 shows an exemplary user interface where the user has selected one of the menu items on the home screen menu, namely, the “Search” item. FIG. 8 shows an exemplary user interface where the user is presented with a screen to filter available puzzles based on their number of pieces within a certain distance radius from the user's current location.

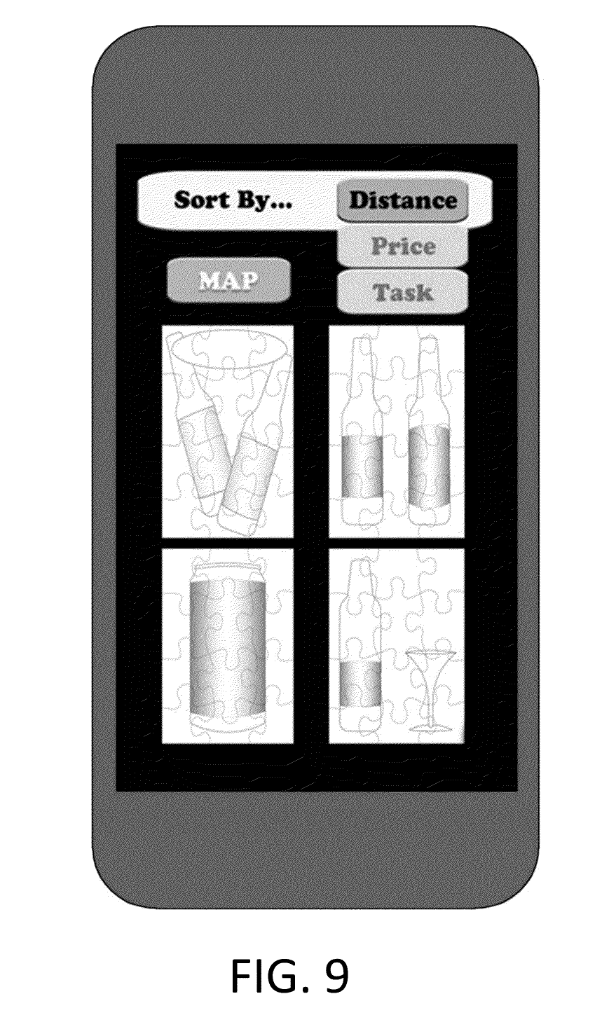

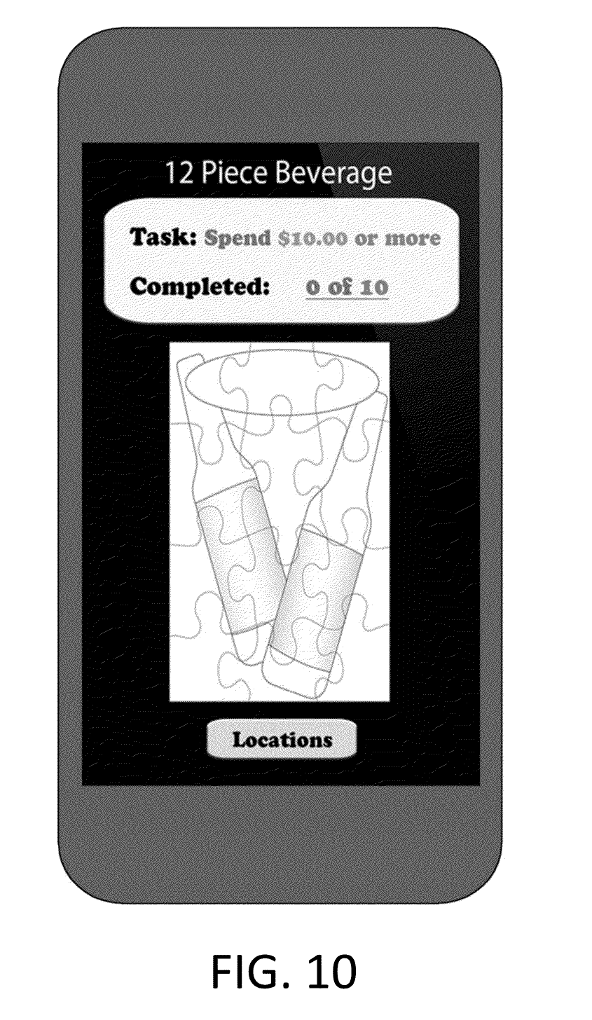

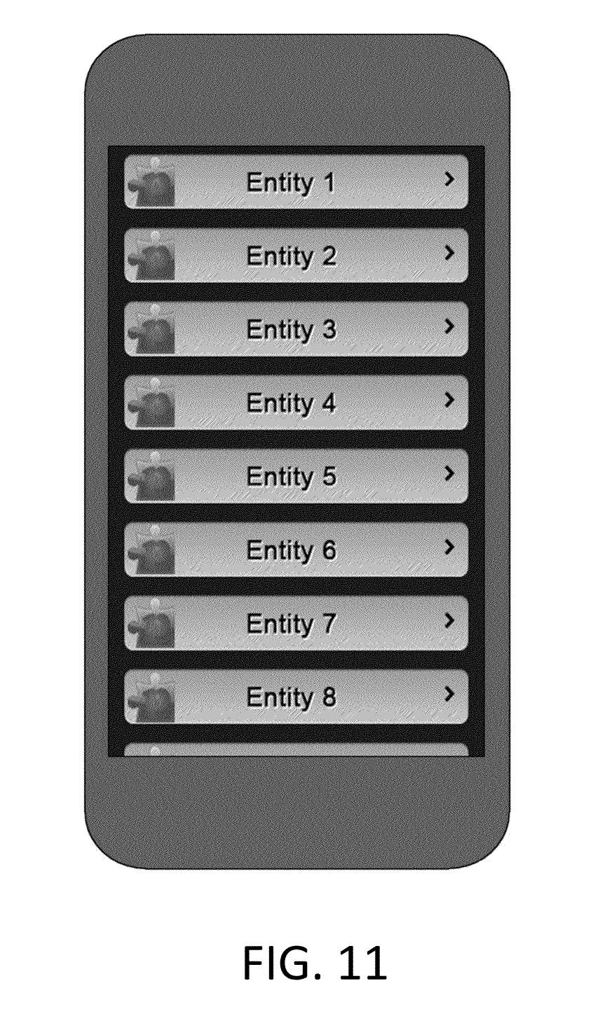

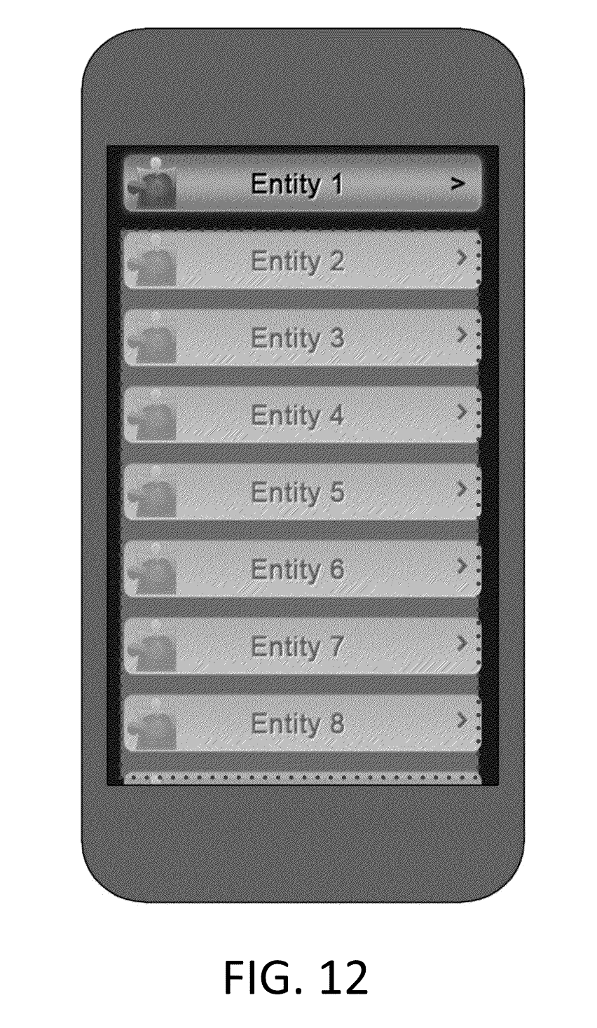

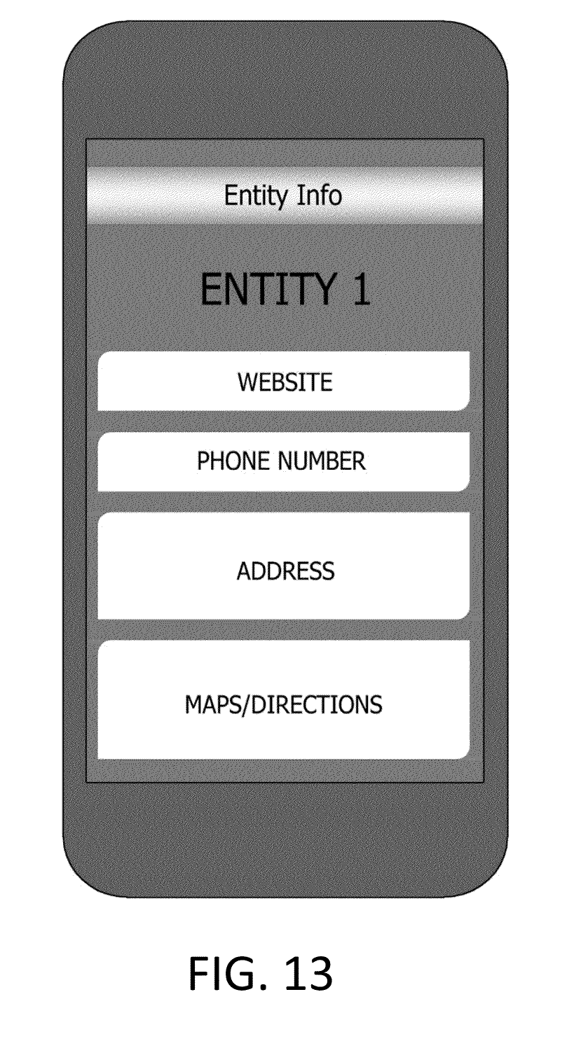

FIG. 9 shows an exemplary user interface where the user is provided a view of available puzzles based on the filter criteria of the user and/or the PPPE, and is given the ability to sort the puzzles by additional filter specifics such as, but not limited to, distance, price, and/or task. FIG. 10 shows an exemplary user interface where the user is presented with the specifics of a task or tasks of the selected puzzle. FIG. 11 shows an exemplary user interface where the user is presented with a listing of the various sponsoring entities for the puzzle pieces for the selected puzzle. FIG. 12 shows an exemplary user interface where the user has selected one (entity #1) of the puzzle piece locations. The selected item is preferably highlighted, or the color changed but, for convenience of illustration herein, the non-selected entities 2-8 are shown as being dimmed. FIG. 13 shows an exemplary user interface where the user is presented with the location information of the selected entity, and other interactive functionality.

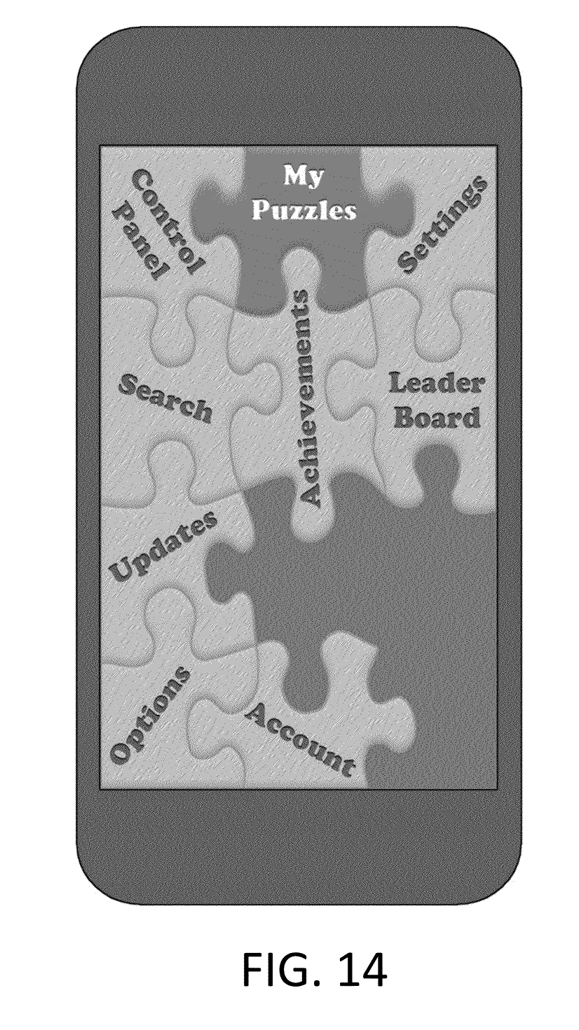

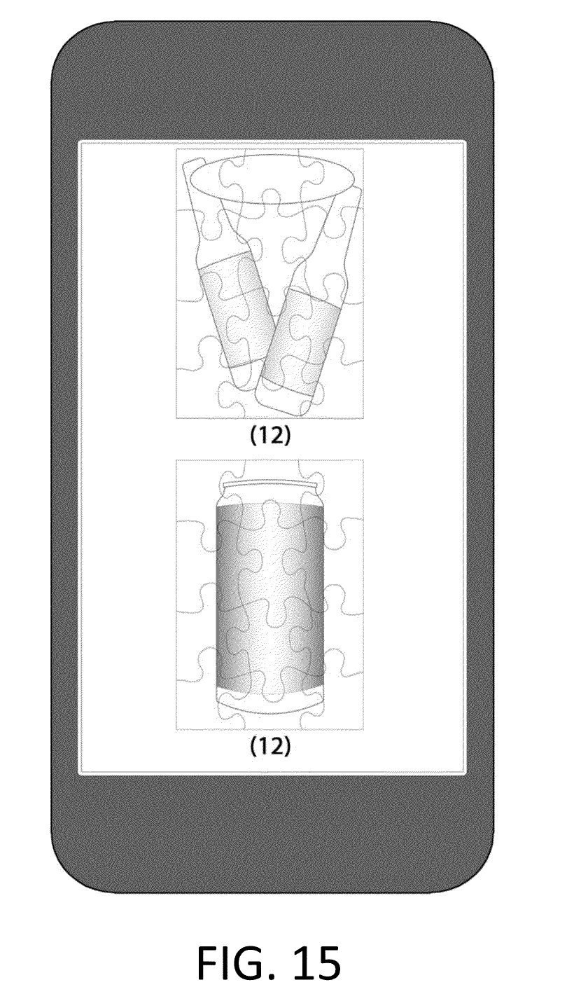

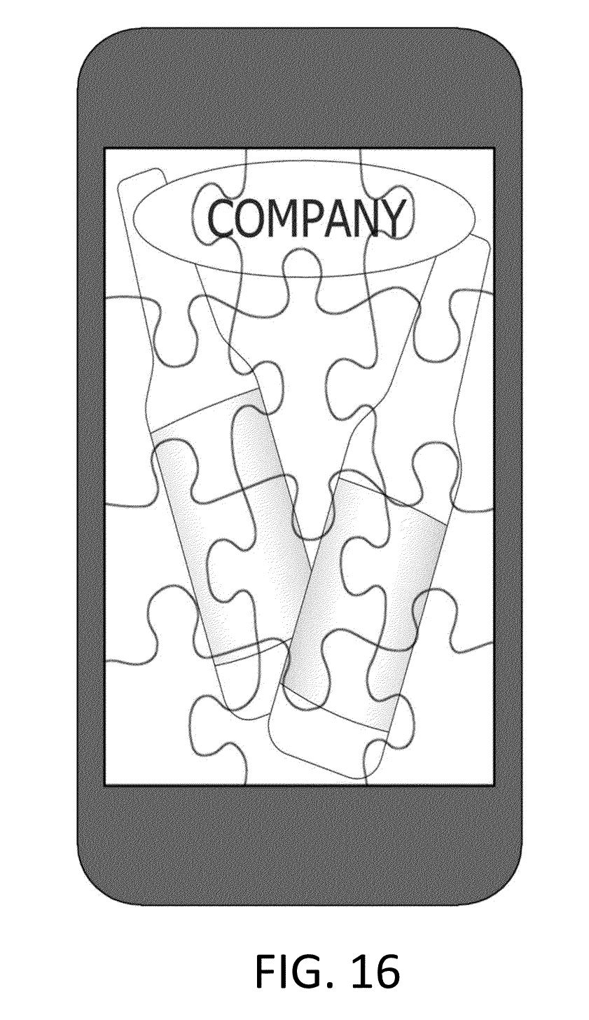

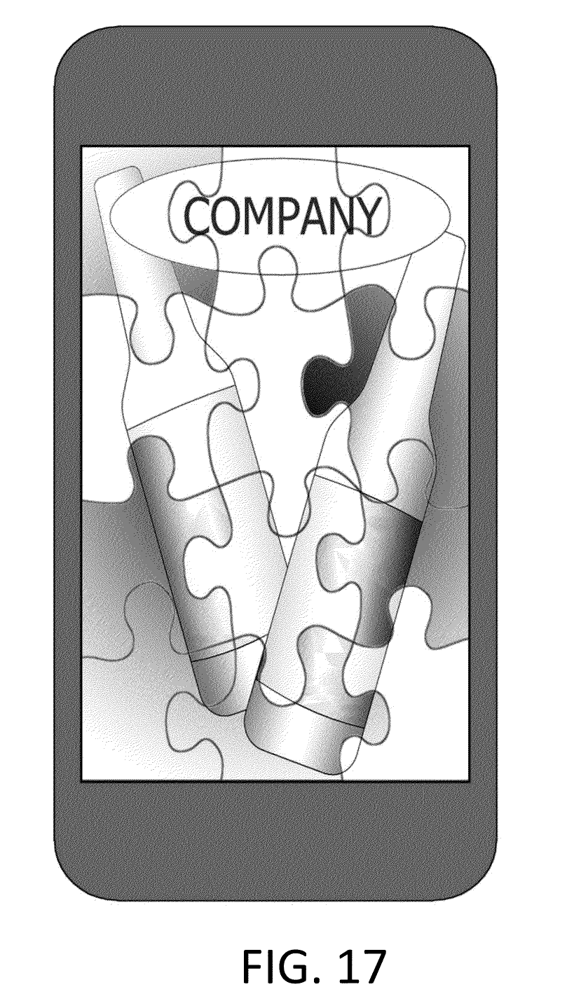

FIG. 14 shows an exemplary user interface where the user is presented with the home screen menu and where the user is selecting the menu item for “My Puzzles”. FIG. 15 shows an exemplary user interface where the user is presented with an icon view of the user's active puzzles. Although simple, grayed-out shapes (bottles, a can) are shown for convenience of illustration, the display would preferably depict the actual colors and shapes of the bottles and cans, including names, logos, banners, etc. FIG. 16 shows an exemplary user interface where the user has selected and is presented with a display of one of the user's active puzzles where no pieces have been obtained. FIG. 17 shows an exemplary user interface where the user is presented with a display of one of the user's active puzzles showing that 6 pieces (shaded) of the 12 puzzle pieces have been obtained. Although simple shading has been used for convenience of illustration, the obtained pieces may be in one color and the non-yet-obtained pieces may be in another color, and/or may be flashing, if desired, to draw the user's attention to those pieces.

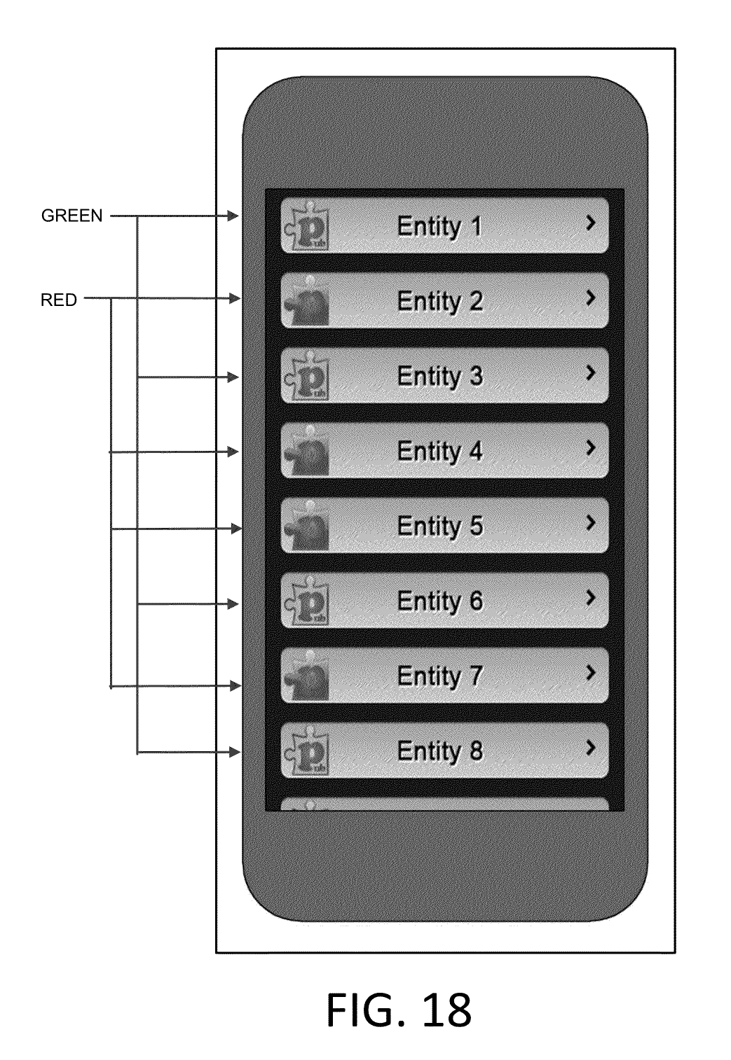

FIG. 18 shows an exemplary user interface where the user is presented with a view of the puzzle piece locations where puzzle piece icons have changed color based on one or more pieces having been obtained. For convenience of illustration in a printed non-color document, the obtained pieces have been labeled as “green” and the not-yet-obtained puzzle pieces have been labeled as “red”.

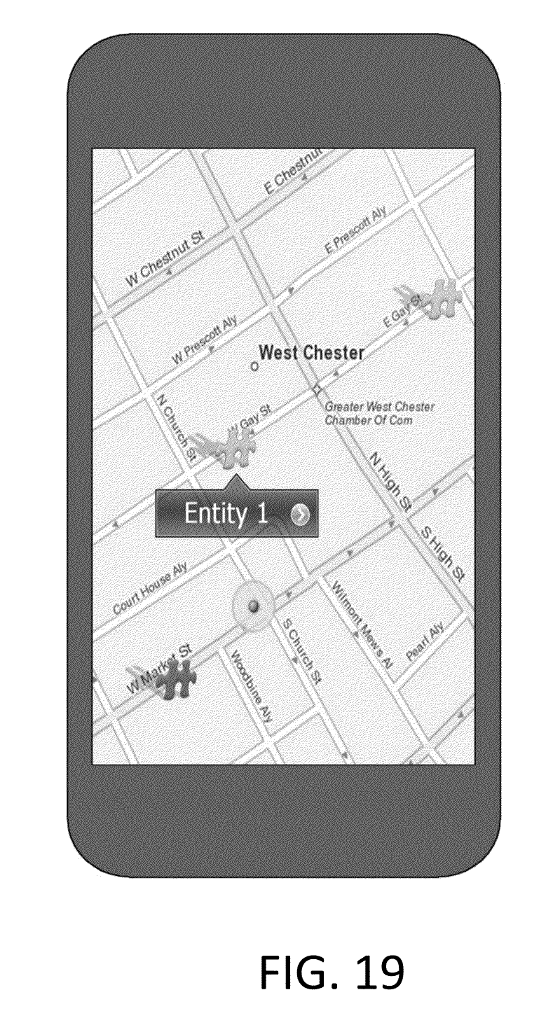

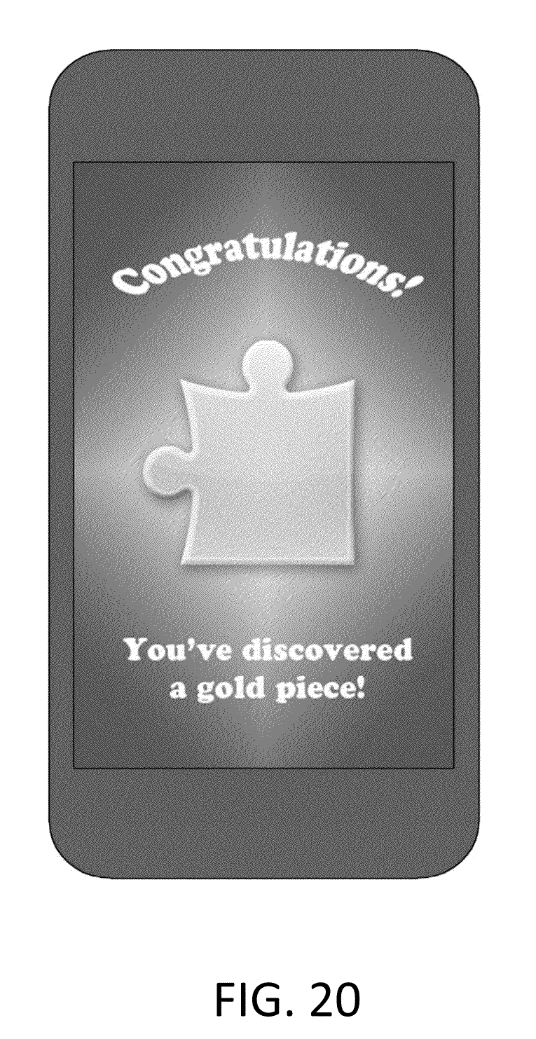

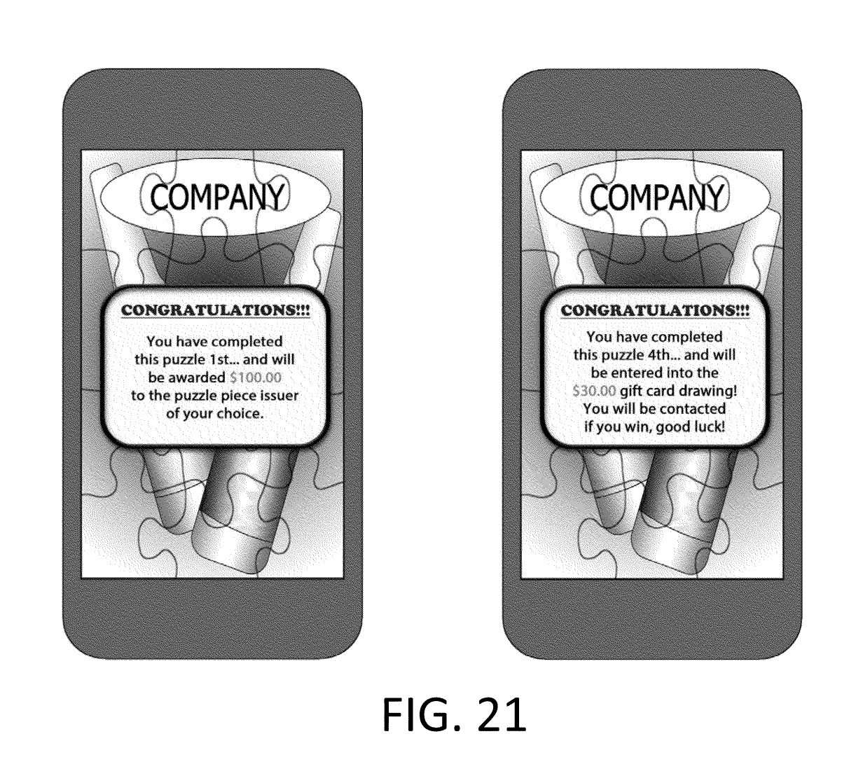

FIG. 19 shows an exemplary user interface where the user is presented with a map search view of puzzle piece locations based on the user selected filter information such as illustrated in FIGS. 8-13. FIG. 20 shows an exemplary user interface where the user is presented with a screen notifying the user that he or she has discovered a special puzzle piece. FIG. 21 shows two examples of a user interface where the user is notified that they have finished the puzzle, in what position they have finished, and any resulting reward.

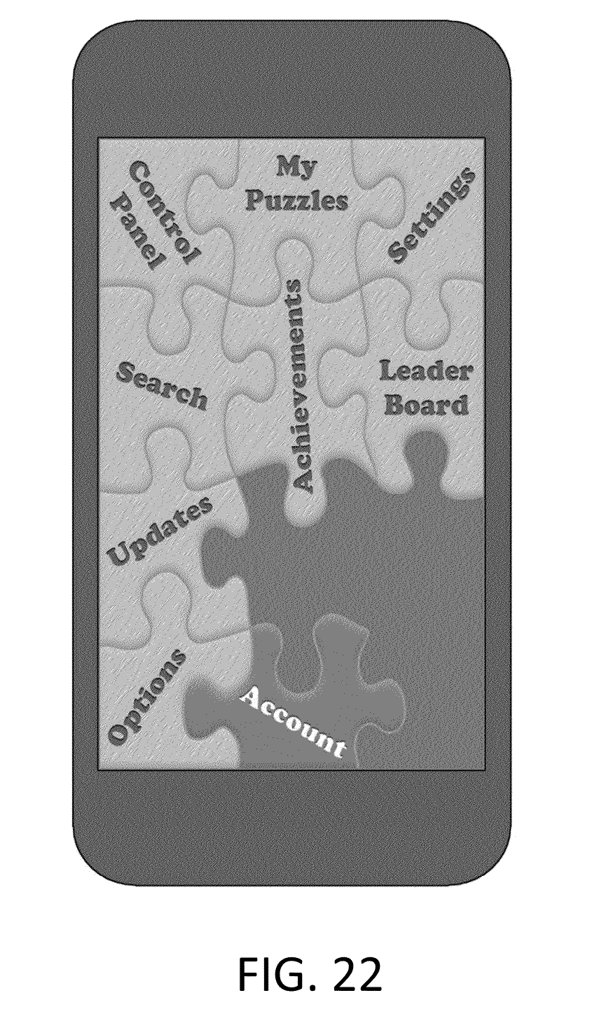

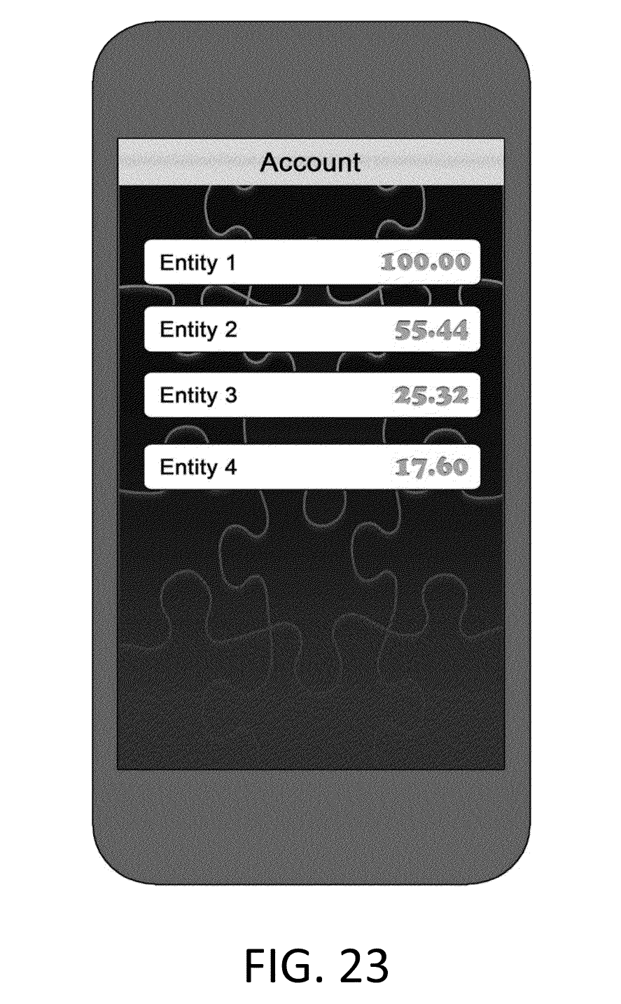

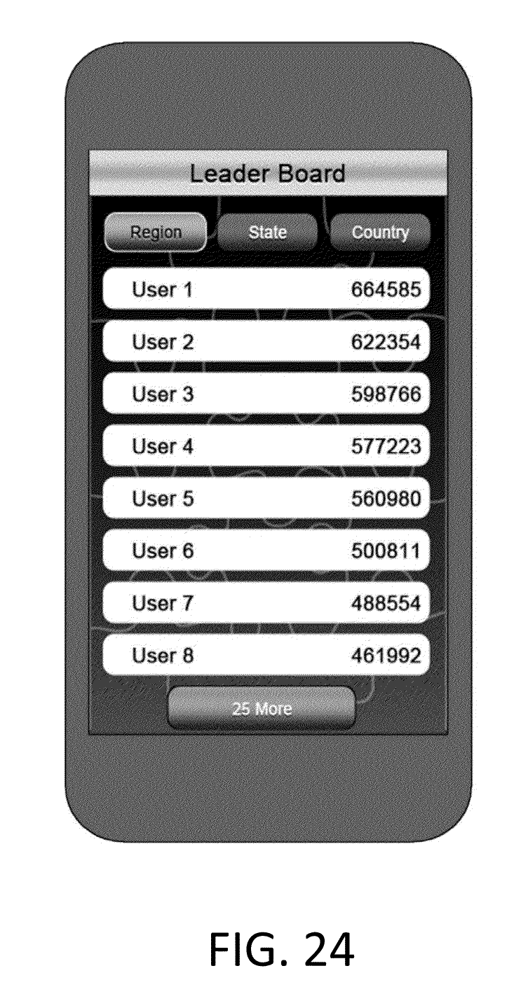

FIG. 22 shows an exemplary user interface where the user is selecting the account menu item from the home menu screen. FIG. 23 shows an exemplary user interface where the user is presented with a listing of completed puzzles and the rewards associated with those completed puzzles. FIG. 24 shows an exemplary user interface where the user is presented with a listing of the leader or ranking board, associated point values, and regional area filtering options.

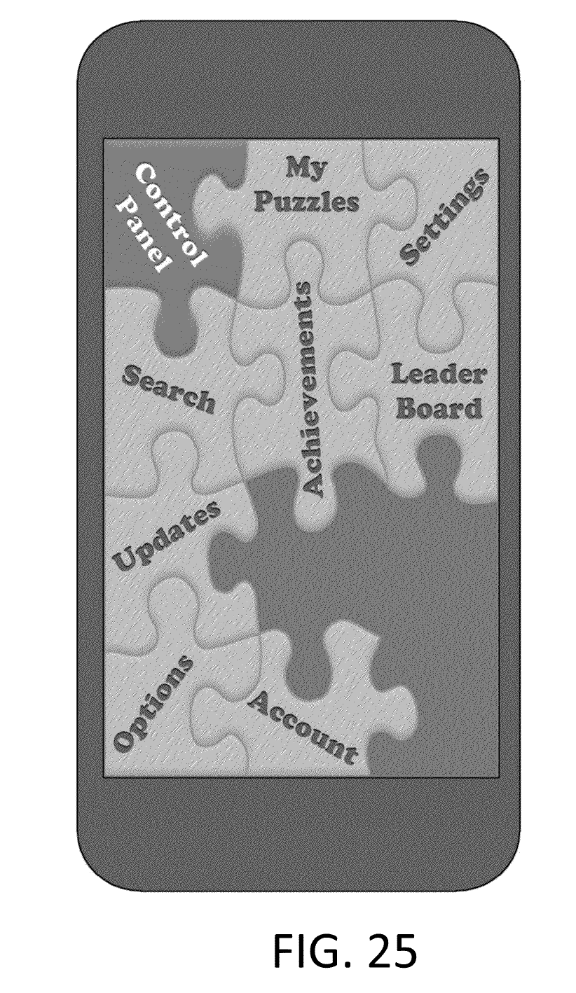

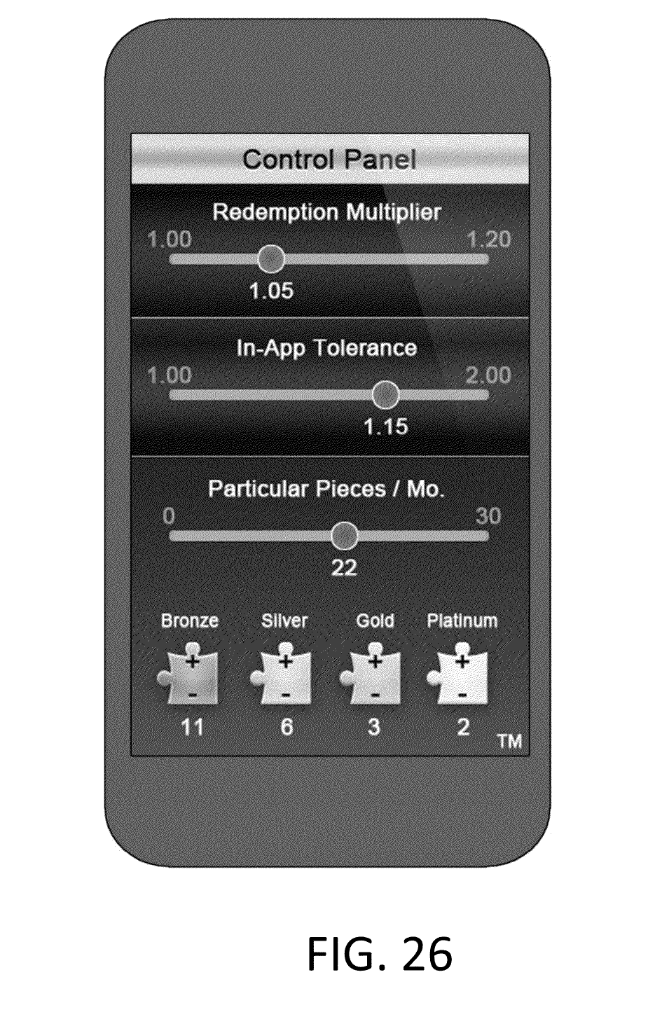

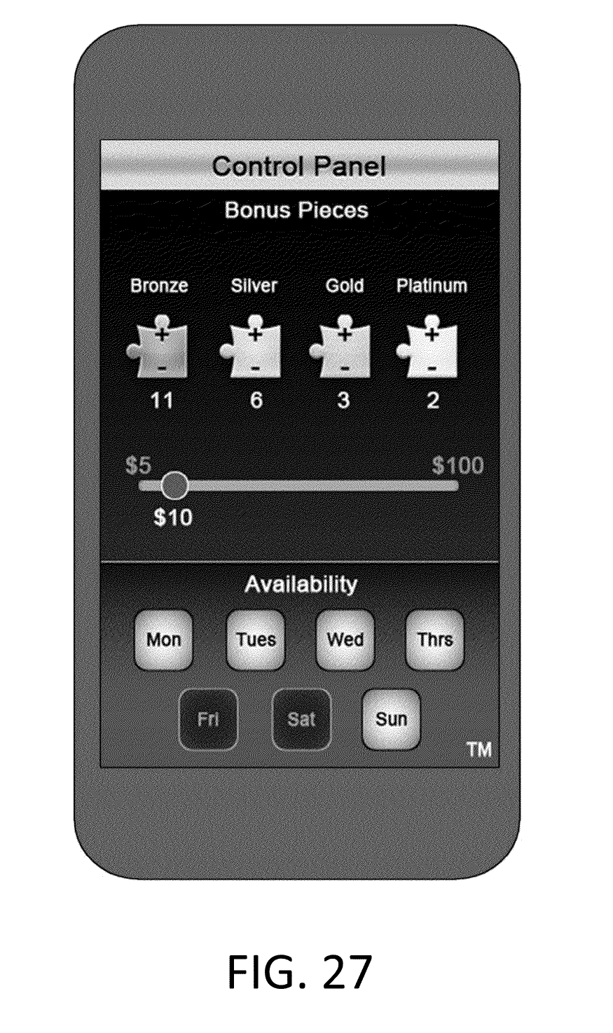

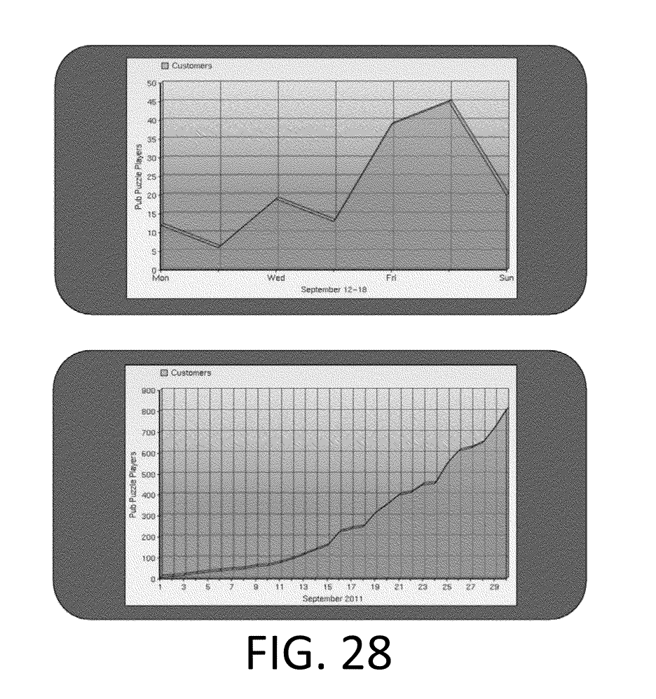

FIG. 25 shows an exemplary user interface where the user is presented with the display of the home screen and with the Control Panel menu item selected. FIG. 26 shows an exemplary issuer user interface where the user is presented with a display of issuer adjustable variables of their game offerings. FIG. 27 shows an exemplary issuer/provider/sponsor user interface where the issuer is presented with some of the issuer adjustable variables. FIG. 28 shows an exemplary user interface where the issuer is presented with metric information based on issuer or administrator selected criteria.

With the above information in mind, some additional implements, variations, and features will be discussed below.

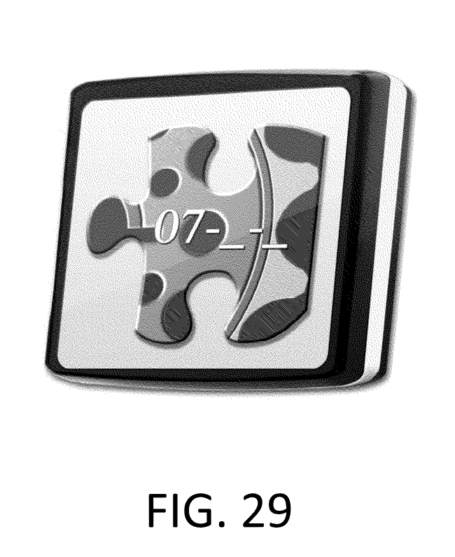

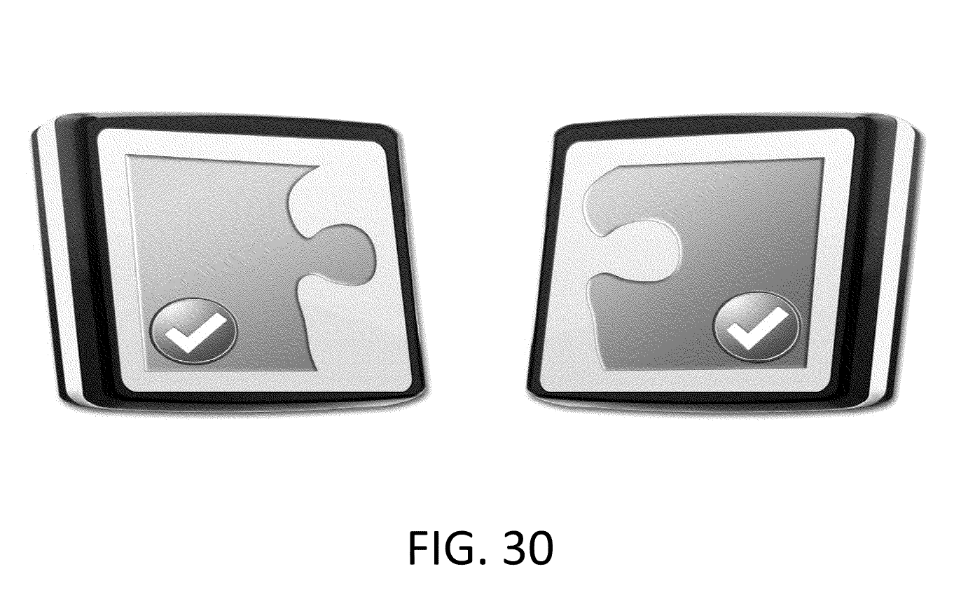

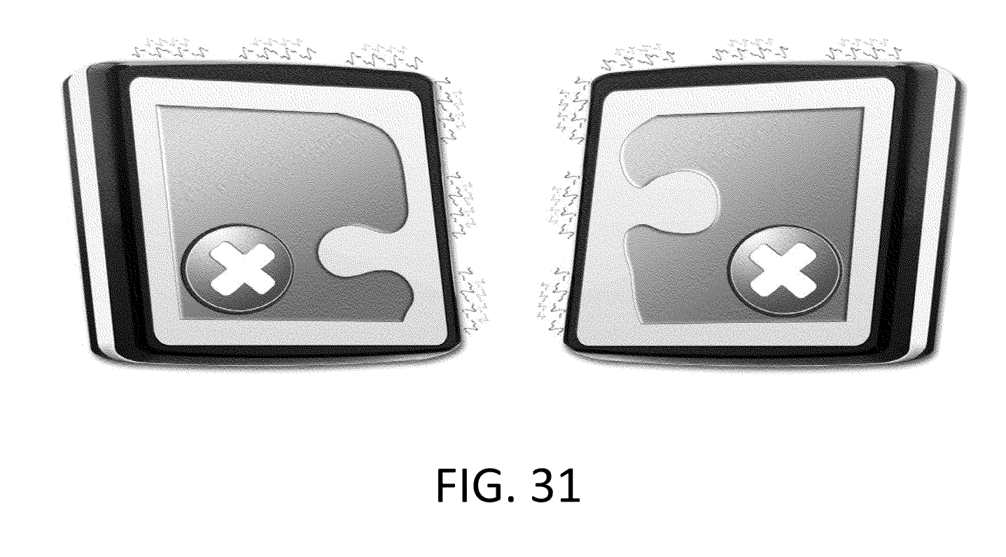

FIG. 29 shows an exemplary user interface where the user is presented with a single piece puzzle to be completed in a specialized event or use. FIG. 30 shows an exemplary user interface where each user is presented with a single piece puzzle to be completed in a specialized event or use, such as a dating event. The puzzle piece of a user is preferably based upon the user's profile and preferences. When two devices having matching (complementary) puzzle pieces are put within proximity to each other, they indicate a valid match, e.g., the devices 110 are “matching” devices, or the users 105 are “matched” to each other. FIG. 31 shows an exemplary user interface where two non-matching devices are put within proximity to each other and indicate an invalid match. In one embodiment, broad matching criteria are used so that a puzzle piece of one user may match the puzzle piece of several other users. This is useful in forming teams or groups and in quickly identifying another user who may have similar interests. In another embodiment, narrow matching criteria are used so that a puzzle piece of one user may match the puzzle piece of only one or two other users. This is useful in a dating service scenario.

In another embodiment, the specified task requires that two or more users need to be in a single location to complete a puzzle, that is, each person may be considered to be a puzzle piece. As each person enters the specified area or location, a puzzle piece would change in appearance to reflect the presence of that person and the presence of all the designated users would result in the completed or final puzzle image being displayed. That image completion could trigger rewards/discounts/prizes where those users are currently gathered. One reward could be for example, a “clue” to one or more additional gathering locations, a “group rewards scavenger hunt” where the hunt is for those locations. Also, if the various users are part of a team, then the task requirement may be that one or more of those users go to a different place(s) or do a different task(s) before the team meets at a specified location, or the users might not even have to meet at any location in order to obtain the reward(s) for the team reaching its assigned goal. That is, once the last task has been completed, the team users will be notified that the goal has been reached, and the reward(s) displayed, wherever the users happen to be.

Through a puzzle-based interaction system as disclosed herein, an entity can sponsor an entire electronic puzzle or a single piece of an electronic puzzle. Through user interaction with the puzzle, an entity might create and maintain consumer loyalty and even obtain new customers.

A user may obtain each piece of an electronic puzzle by performing a predefined action. For example, a puzzle piece might be obtained by “checking-in” at a particular location, by purchasing a product or service, by viewing a particular portrait or painting, by entering a code located (and possibly hidden) at one or more locations, or by performing another type of action. A user might then be provided certain rewards for obtaining all of the pieces of the electronic puzzle. Completion of an entire puzzle within a certain set of conditions, such as within a certain time period or with no more than N team members, or more quickly than another team, or obtaining more puzzle pieces within a specified time than another team, may result in a premium for the user on any of the incentives or rewards.

Gamification is a process of applying game mechanics and game design techniques in non-game contexts. For example, the concepts and technologies described herein offer entities the ability to create gamification events in the form of electronic puzzles, with the puzzle pieces representing certain subjects, actions, events, accomplishments, and/or other aspects. These events may advertise to potential customers, engage new customers, retain, engage, and motivate existing customers, and otherwise create and/or improve a relationship between customers and entities. It should be appreciated that the embodiments disclosed herein might be utilized in many different contexts, with many different types of desktop and mobile applications, and with other technologies. As a result, the disclosure presented herein should be read as being illustrative rather than limiting.

Gamification of certain types of technology, as disclosed herein, may offer many benefits to health professionals, educators, governments, service providers, product retailers, and technology users themselves. Benefits of gamification may include, but are not limited to, increases in the frequency and duration of use of software (mobile, Web and “fat” client), in new purchases and follow up purchases, and in engagement and interaction by users, consumers, and/or constituents.

Additionally, trends and specific use metrics within a gamification environment or a module may reveal important information about users relating to their habits, personality, preferences, attention, activities, and actions (collectively, “traits”). Trait information may have an impact on procedures for business and commerce, collecting and disseminating information, promoting change, and other activities. Moreover, trait information may be valuable to various entities to manage their own products, services, information, and consumers. Trait information may also be valuable in the further development of gamification and other engagement solutions.

There are many entities who may directly benefit from this trait information, including but not limited to: health providers; schools and universities; museums; countries, states, and cities; national parks; tourism and convention bureaus, managers and venues; entertainment venues; consumer products retailers and brands; grocery retailers; travel and lodging providers; transportation providers; financial planners; manufacturers; geocaching groups; politicians; the family unit; and bars and restaurants. Furthermore, many persons desire and enjoy interaction that engages them and/or may reward them with discounts, coupons, prizes, games, and other information or items of value.

In embodiments of the puzzle interaction system disclosed herein, a system, through an automated process or manually by an administrator, makes a public or private electronic puzzle available of N puzzle pieces. A sponsor of the puzzle might define the number of puzzle pieces. A pre-solved puzzle background may be defined that includes a watermark of a graphic or textual content to serve as an advertisement, source for information, map or other content, with or without lines marking the puzzle piece shapes for the N number of puzzle pieces, and this background may be the image of the finished puzzle. The electronic puzzle piece shapes may be jigsaw in nature, square, circular, counties, states, or countries, or other shapes. The electronic puzzle's individual puzzle pieces may depict graphic or textual content and serve as an advertisement, source for information, map or other content.

Each electronic puzzle may be used as a simple game for a user or users, or as a competition amongst users, groups of users, or teams of users. As a simple single game, completion of the puzzle may result in accumulation of points, prizes, special puzzle pieces, coupons, and other types of incentives (“rewards” or “incentives”). Partial completion of a puzzle may also result in incentives based on metrics established for rewards and incentives. Completion of a puzzle within a certain set of conditions may result in a premium for the user/consumer on any of the incentives or rewards. Each individual puzzle piece or combination of puzzle pieces obtained may result in the award of incentives or rewards to users, groups or teams.

In some embodiments, a PPPE might be permitted to sponsor one or more individual puzzle pieces. In other embodiments, a PSE might be permitted to sponsor an entire puzzle. A PPPE or a PSE may receive incentives as users obtain puzzle pieces or complete puzzles. For example, the puzzle piece task is to buy a particular product or service, so the user buys the product or service and the PPPE and/or PSE receive a benefit in the form of a sale of the specified product or service. As a competition, completion of the electronic puzzle may also follow a set of conditions established for the puzzle including the primary condition being a competition on the puzzle. Competition puzzles may be between individual users, within segmented groups of users, between teams of users or any combination of these.

An electronic puzzle may be created where the full puzzle is made up of puzzle pieces where each individual piece is for a different PPPE, multiple pieces per PPPE or a combination of these, or where the entire puzzle is dedicated to a single PSE. In an example of where each puzzle piece is for a different PPPE, an entity desiring to sponsor a full puzzle, for example a sports drink brand or distributor, may create a puzzle where they are the PSE. The PSE's logo, graphic, advertisement, and/or other identifying or advertising information may show as a watermark for the puzzle background which may be the image in the completed puzzle. Vendors of these sport drinks within a geographically defined area may have the opportunity to be a PPPE for that puzzle, with each vendor allowed to have only a single puzzle piece in the puzzle. Each PPPE may assign a task set (one or more tasks in any order or a specified order) in the system to be completed by a user for the user to obtain the puzzle piece.

For example, if there are multiple pieces per entity or in combination the PSE may follow the same process as in an individual piece per PPPE. If, for example, all the pieces of the puzzle are provided by a PSE, then that PSE establishes the number of puzzle pieces, conditions for completing the puzzle and tasks to obtain each puzzle piece. The PSE may however, allow specific PPPEs to have the ability to have multiple puzzle pieces and to establish additional conditions and/or sub-conditions for completing their particular sets of puzzle pieces.

A PSE may be any type of entity (e.g., a not-for-profit entity, government, individual, a commercial entity, etc.). It may even be an entity that is not choosing to advertise in the puzzle or on the individual puzzle pieces, but rather to sponsor a puzzle for other purposes such as motivation, education, celebration, promoting an ancestry or heritage, or other non-commercial reason. A PSE may choose to sponsor a puzzle or set of puzzles and allow users to create their own puzzles for themselves, families, friends or anonymous users to solve.

Puzzles may be set up and governed by a condition or set of conditions established by the PSE and/or sub-conditions established by the PSE, and/or established by users given the ability by the PSE to build their own puzzles, which ability may also be subject to one or more conditions established by the PSE. Conditions for puzzles may range from global conditions including, but not limited to, completing a puzzle in a specific order, completing a puzzle within a certain timeframe, over a certain timeframe, with a certain frequency, or other general condition; or the conditions may be designed specifically based on demographics, usage, psychological or heuristic, algorithmic, machine-learned or other factors.

Additionally, a condition of a puzzle may not even be known to the user or manifest itself until after the puzzle is completed. For example, once all the puzzle pieces have been obtained, the puzzle pieces may be shuffled. The completion of the puzzle, or a premium on the completion of the puzzle, is then contingent upon the user(s) unscrambling the puzzle, or the user's rank in the speed with which the puzzle was unscrambled.

Conditions may be saved for selection in future electronic puzzles. Further, puzzles may be cloned for future use or editing and then use. Obtaining an electronic puzzle piece may be tied to zero, one, or more tasks. These tasks include, but are not limited to, the purchase of one or more specific items or services, “checking in” while at a particular location, finding a hidden object or feature, such as but not limited to a number or a code, completing a puzzle within a puzzle piece, solving a challenge, playing a game, reading content, scanning a bar code, a quick response (“QR”) code or some other type of code, or other task.

Certain conditions or tasks may enable users to obtain premium or special pieces when the condition is met or task is completed. Premium or special pieces may result in special rewards or incentives, or enable users to use those pieces in alternate or special ways within a puzzle. Incentive or reward redemption functionality may be provided through ecommerce, mobile commerce, Quick Response codes, bar codes, or other types of codes, text messaging, email, near-field communications (“NFC”), application, code number, and other mechanisms.

Also, tasks may be saved for selection and use in other puzzles. Tasks also may be cloned for editing and use in other puzzles. Users may save the name and/or designation of one or more PSEs and/or PPPEs to their favorites list and set a notification preference to be notified when new puzzles from their favorite PSE or PPPEs are available or are coming available.

When a puzzle has been set up and published, users may be notified of the available puzzle by being listed on Web sites of the PSE, PPPE, marketing companies, or other entities, and/or through push messaging, text, email, phone call, or other communications mechanisms. When all the puzzle pieces are allocated within a puzzle or as the pieces are being allocated, the locations of the PPPEs may be included or presented in a list or marked with a pin on a map or other informational source within the puzzle information. Map “pins” presented on the display may be conventional pin shapes, shapes of puzzle pieces, logos of PPPEs, or another design. These locations may be sorted, grouped, filtered, etc. by various criteria including but not limited to proximity, interest, duration, incentives, or other criteria. Additionally, users may search for puzzles within the system or for apps that meet user-specified search criteria.

A user may login or may be anonymous and identified only by a device designation. A user may build a profile, set up preferences, etc. that can be applied to their use of the system. After a user has completed the task, or tasks, to obtain a puzzle piece, the user may obtain the validation of the piece from the PPPE through any of many means including but not limited to near field communication, Bluetooth, transaction or communication app, QR code, barcode, other graphical code text message, email, physical printout of an alphanumeric code, etc.

When a piece is validated, that piece on the puzzle may be changed to a full color puzzle piece signifying that the piece has been obtained. With validation, the reward for obtaining the piece will be added to the user's reward inventory within the puzzle systems database. Puzzle piece locations where the user has obtained one or more puzzle pieces may be displayed to the user with a different color of map pin or designation in a list, or in another manner. Additionally, rewards in the user's inventory may also be displayed or presented with a different color or icon or designation in the inventory display that may be presented in a user's home puzzle screen.

Users may be required or allowed to set preferences to “share” their involvement in the system described herein. Involvement in the system may include, but is not limited to, participation in existing puzzles, past puzzles, future puzzles already selected or notice of users winning a puzzle or placing (1st, 2nd, 3rd . . . ) in a puzzle. Users may also choose to “share” individual puzzle pieces that they have obtained and desire to share. Sharing may include, but is not limited to “liking” in Facebook®, tweeting in Twitter®, pinning in Pinterest®, other social media and networks, internally within the puzzle application, etc.

Users may have, or be given, the ability to post reviews or comments about their obtaining a puzzle piece, the competition in the puzzle, completion of the puzzle, the PSEs, the PPPEs, products or services from a particular PPPE, etc. Upon completion of a puzzle, the system disclosed herein might publish the results of the puzzle completion based on certain conditions. Such publication may be by, for example but not limited to, a Web page, a reporting or administration portal or system, lists, e-mail, push messaging, text messaging, and other communication mechanisms.

Also, avatars may be created as individual graphic entities or embedded within the systems mapping and data point pins and markers. The functionality of these avatars would include but not be limited to: display of static and dynamic data metrics through gauges, colors, fill completion, etc.; interaction with users to access and detail the data metrics; assist users in identifying additional puzzles and puzzle pieces for the users completing puzzles; provide system use planning; and interact socially with additional avatars of the same user and avatars of other users; and receive and give virtual and physical gifts and rewards from their users and other participating entities. Through the functionality of, data gathering from, and interaction with, these avatars, the system can gather new types of user affinity and intention data which can, among other uses, be used to further refine, encourage, measure, and document usage, search, marketing, understanding, transactions, and other consumer and vendor metrics.

Metrics may also be gathered and analytics functionality applied to, for example but not limited to, user browsing of potential puzzles, PSEs and PPPEs; clicking advertisements, or links, etc.; completing tasks, games, challenges, puzzles; sharing puzzles, pieces, information; recording the time to complete tasks, puzzles, etc.; leaving reviews; etc. Metrics and analytics delivery and presentation may be customized for users, PPPEs and PSEs, and may be delivered to the user by, for example but not limited to, a Web page, reporting or administration portal or system, lists, email, push messaging, and text messaging.

Location-based scenarios may be created and used for bars, restaurants, clothing stores, hardware stores, book stores, and other retailers. In one embodiment the system may be used in a grocery store setting to create engaging puzzles to encourage and reward loyalty and other user interaction. In this embodiment, the puzzle pieces may represent, but are not limited to, grocery and sundry items, tasks or challenges to be accomplished, and other types of items or activities. For example, a grocery store might create a puzzle for shoppers for regular or sales items or a more novel puzzle for a holiday dinner in which the puzzle pieces are the items in the recipes for the meal, or where the user selects main items or categories of items for the meal from a list, or enters them as free text and a puzzle is dynamically created with puzzle pieces for each of the recipe items for the main items of the meal. Purchase of each of the recipe items may enable the user to obtain the relevant pieces and any relevant discounts, incentives, promotions, and/or other rewards.

In a health and wellness environment, the puzzle pieces may represent, but are not limited to, taking medications, taking vitamins, performing exercises, performing wellness tasks; tracking a user's diet, and dieting information such as calories, sodium, and other health and wellness activities. In a tourism environment for cities, states, and countries the puzzle pieces may represent, but are not limited to, visiting destinations such as cities, states, countries, historic sites, or points of interest; gathering information about destinations; and solving challenges or performing tasks at destinations.

For national and state parks, the puzzle pieces may represent, but are not limited to, different parks; points of interest in the parks; plant and animal wildlife to be seen, geologic formations; and solving challenges or performing tasks at the parks. In a charitable environment, the puzzle pieces may represent, but are not limited to, different needs of independent charities, levels of sponsorship or donations, or the charities themselves.

In the investment industry, the puzzle pieces may represent, but are not limited to, different types of investments in a financial plan as a way to visualize an investment mix and to provide a way to educate users about investing. In yet an another embodiment, conferences and conventions, the puzzle pieces may represent tracks attended at the conference, exhibitors visited in the convention hall, solving challenges or performing tasks at the conference, or other types of conference activities.

In an alternative embodiment, for meet-ups such as tech, entrepreneurial, and social, the puzzle pieces may represent individuals or functions at the event, and/or tasks or challenges to be completed. For geocaching, the puzzle pieces may include, but are not limited to, caches to be found or tasks to be completed to find the caches. With respect to theme parks, the puzzle pieces may include, but are not limited to, rides, exhibits, locations, items or food for purchase, challenges or tasks to be completed, or different theme parks themselves.

For sporting and entertainment events, the puzzle pieces may represent, but are not be limited to, events in a tour, games in a season, venues, items for purchase, team scores (touchdowns, homeruns, etc.), players involved, etc. In an alternative embodiment, with respect to transportation and lodging, the puzzle pieces may represent but, are not limited to, trips, segments, mile goals, rental days, night stays, challenges or tasks to be completed, etc.

With respect to education and training, the puzzle pieces may represent but not be limited to homework or assignments, tests taken, information learned, field trips, classes or tracks achieved, challenges or tasks to be completed, etc. In an alternative embodiment, for museums and galleries, the puzzle pieces may represent but not be limited to museums or galleries to be seen, arts or exhibits to be viewed or experienced, challenges or tasks to be completed, etc.

With respect to politics, the puzzle pieces may represent, but are not limited to candidates, platforms, referendums, and items to vote on, detailed information about the aforementioned, challenges or tasks to be completed, etc. In another alternative embodiment, for dating, the puzzle pieces may represent but not be limited to individuals, locations, things to do, days of the week, challenges or tasks to be completed, etc.

For trivia nights, the puzzle pieces may represent, but are not limited to, individuals, teams, individuals in a team, questions, answers, challenges or tasks to be completed, etc. For scavenger hunts, the puzzle pieces may represent, but are not limited to, individuals, teams, individuals in a team, items, questions, answers, challenges or tasks to be completed, etc.

With respect to fantasy football or other sports spectator interactive competition, the puzzle pieces may represent, but are not limited to, sports players; information on players; sports games; competition participants teams; leagues; competition scoring events such as passing, yards, sacks, touchdowns, etc.; challenges or tasks to be completed; etc. In another illustrative alternative embodiment, such as gambling venues, the puzzle pieces may represent, but are not limited to, games, locations, challenges or tasks to be completed, etc. Other scenarios are also possible and contemplated.

In another embodiment, there may be single players within a public or semi-public puzzle, and there may also be single players within segmented groups of users who may be grouped randomly, by demographics, by traits, by likes and dislikes, or other grouping metrics, info or methods. Group puzzles may stand alone, consist of other groups or teams, etc., and groups may compete with other groups. Puzzles may be created for team participation, where puzzle pieces may or must be obtained by different users on the team. Teams may consist of individuals, groups or other teams. Obtaining puzzles pieces and/or partially or fully completing puzzles may result in rewards or incentives.

In a commercial environment, one party may provide the system 115, another party may be an establishment (a physical location, such as a restaurant or a museum), another party may be an advertiser, and another party may be a user. The user is provided with a challenging and rewarding experience, the advertiser exposes the user to its products and services, establishment receives the benefit of users patronizing the facility, and the system provider may receive compensation from the establishment, the advertiser, the web service provider, and/or the user based upon, for example, revenue generated, entry fees, promotional fees, etc. Thus, each of the parties receives a benefit. Further, users can be offered, and receive, substantial rewards and prizes for doing what the user may have already planned on doing.

In another embodiment, puzzles may be created by users rather than commercial or other sponsors. The puzzle may be sponsored by another entity or have no sponsor, and provided free or in a subscriber model to users for user-created puzzles. A user-created puzzle may have conditions pre-established by the system or a sponsor, and also allow further conditions to be established by the creating user. For example, a restaurant, city, or museum may want to sponsor puzzles where users can create their own puzzles for public, private group or individual use, with their own challenges and tasks for completion.

In yet another embodiment, puzzles may be created for use on specific devices and would support special scenarios for a person, group, team and any combination of the three interactions. An example of this embodiment would be a nine piece puzzle (for example, a tech meet up) where the puzzle pieces are delivered individually and are not visualized with the rest of the puzzle. Whether on a device specifically designed for this embodiment, a device suited for this embodiment or any other device that the system is adapted for, a single puzzle piece is obtained through a task, challenge, purchase or other scenario.

The puzzle piece may have a picture, portion of a picture, a code number, portion of code number, etc. When a puzzle piece is obtained, the user with the puzzle piece looks for others with potential matching puzzle pieces. In this example, the puzzle piece has a group number followed by two blanks for additional numbers, the 1st, the number of the puzzle piece of the 2nd, the total number of puzzle pieces in the puzzle.

As users find other users with matching puzzle pieces to the puzzle of which they are a part, the puzzle pieces may be authenticated as valid pieces, validated as relevant pieces, etc. by proximity of the devices, codes, network connections, Bluetooth, etc. and are marked as related pieces. Obtaining pieces and completing the puzzle may result in rewards or incentives. Additionally, completing the puzzle reveals the piece number and total number of puzzle pieces for each piece in the puzzle which serves as the identification number of the individual as the group participates in the purpose of the tech meet up. An example of a screen display provided in this embodiment is shown in FIG. 29.

Another example of this embodiment would be a two piece puzzle at a dating event where the puzzle pieces are delivered individually and not visualized with the rest of the puzzle. Whether on a device specifically designed for this embodiment, a device suited for this embodiment or any other device that the system is adapted for, a single puzzle piece is obtained through a task, challenge, purchase or other scenario such as filling out a personal survey that is used to match up two individuals.

A puzzle piece may have a picture, portion of a picture, a code number, portion of code number, etc. When a puzzle piece is obtained, the user with the puzzle piece looks for others with the matching puzzle piece. When the user finds the other user with the matching puzzle piece to the puzzle of which they are a part, the puzzle pieces may be authenticated as valid pieces, validated as relevant pieces, validated by proximity of the devices, codes, network connections, Bluetooth, etc., and are recorded and/or marked as related pieces. Obtaining pieces and completing the puzzle may result in rewards or incentives. Additionally, completing the puzzle reveals the piece number and total number of puzzle pieces for each piece in the puzzle which serves as the identification number of the individual as they participate in the purpose of the event.

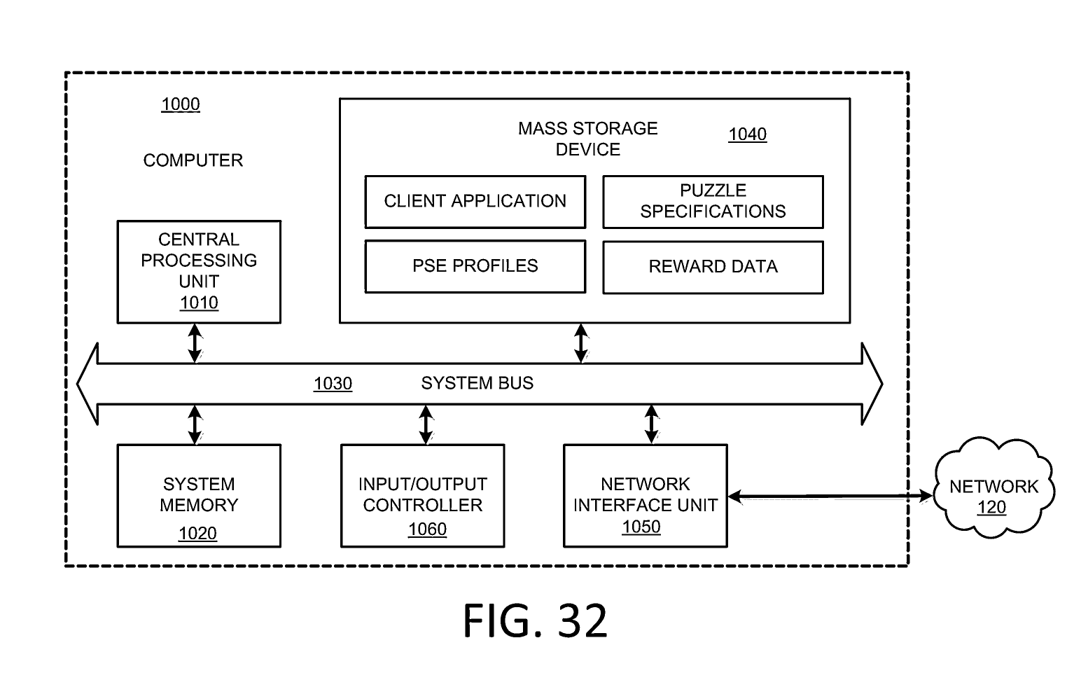

FIG. 32 is a computer architecture diagram showing illustrative computer hardware architecture for a computing system 1000 capable of implementing the embodiments presented herein. This exemplary computer architecture might be utilized to implement a mobile device, an application server, or any of the other computer systems disclosed herein. It should be appreciated that the computer architecture shown is merely illustrative and that other types of computer systems might also be utilized to implement the embodiments described herein. It should also be appreciated that this architecture is generally appropriate for both the personal electronic device and a server on the system.

The exemplary computer includes a central processing unit (“CPU”) 1010, a system memory 1020, and a system bus 1030 that couples the memory to the CPU. The computer further includes a mass storage 1040 device for storing program modules. For example, the mass storage device might store some or all of the program modules and data shown in FIG. 1 and described above.

The mass storage device is connected to the CPU through a mass storage controller (not shown) connected to the bus. The mass storage device and its associated computer-storage media provide non-volatile storage for the computer. Although the description of computer-storage media contained herein refers primarily to a mass storage device, such as a hard disk or CD-ROM drive, it should be appreciated by those skilled in the art that computer-storage media can be any available computer storage media that can be accessed by the computer.

By way of example, and not limitation, computer-storage media may include volatile and non-volatile, removable and non-removable media implemented in any method or technology for storage of information such as computer-storage instructions, data structures, program modules, or other data. For example, computer storage media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information in a non-transitory fashion and which can be accessed by the computer. It should be appreciated by those skilled in the art that computer-readable storage media can be any available media that provides for the storage of non-transitory data and that may be accessed by the computer. The term computer-storage media as used herein does not, however, encompass propagated signals per se.

According to various embodiments, the computer may operate in a networked environment using logical connections to remote computers through a network, such as the network 120 shown in FIG. 1. The computer may connect to the network 120 through a network interface unit 1050 connected to the bus. It should be appreciated that the network interface unit may also be utilized to connect to other types of networks and remote computer systems. The computer may also include an input/output controller 1060 for receiving and processing input from a number of input devices and providing output data to one or more output devices, including input/output devices.

The bus may enable the processing unit to read code and/or data to/from the mass storage device or other computer-storage media. The computer-storage media may represent an apparatus implemented in the form of storage elements that are implemented using any suitable technology, including but not limited to semiconductors, magnetic materials, optics, or the like.

The program modules stored on the computer-storage media may include software instructions and data which, when loaded into the processing unit and executed, cause the computer to provide the functionality disclosed herein. The program modules may also provide various tools or techniques by which the computer may participate within the overall systems or operating environments using the components, flows, and data structures discussed throughout this description.

In general, the program modules disclosed herein may, when loaded into the processing unit and executed, transform the processing unit and the overall computer from a general-purpose computing system into a special-purpose computing system. The processing unit may be constructed from any number of transistors or other discrete circuit elements, which may individually or collectively assume any number of states. More specifically, the processing unit may operate as a finite-state machine, in response to executable instructions contained within the program modules. These computer-executable instructions may transform the processing unit by specifying how the processing unit transitions between states, thereby transforming the transistors or other discrete hardware elements constituting the processing unit.

Encoding the program modules may also transform the physical structure of the computer-storage media. The specific transformation of physical structure may depend on various factors, in different implementations of this description. Examples of such factors may include, but are not limited to: the technology used to implement the computer-storage media, whether the computer storage media are characterized as primary or secondary storage, and the like. For example, if the computer-storage media are implemented as semiconductor-based memory, the program modules may transform the physical state of the semiconductor memory, when the software is encoded therein. The program modules might also transform the state of transistors, capacitors, or other discrete circuit elements constituting the semiconductor memory.

As another example, the computer-storage media may be implemented using magnetic or optical technology. In such implementations, the program modules may transform the physical state of magnetic or optical media, when the software is encoded therein. These transformations may include altering the magnetic characteristics of particular locations within given magnetic media. These transformations may also include altering the physical features or characteristics of particular locations within given optical media, to change the optical characteristics of those locations. Other transformations of physical media are possible without departing from the scope of the present description, with the foregoing examples provided only to facilitate this discussion.

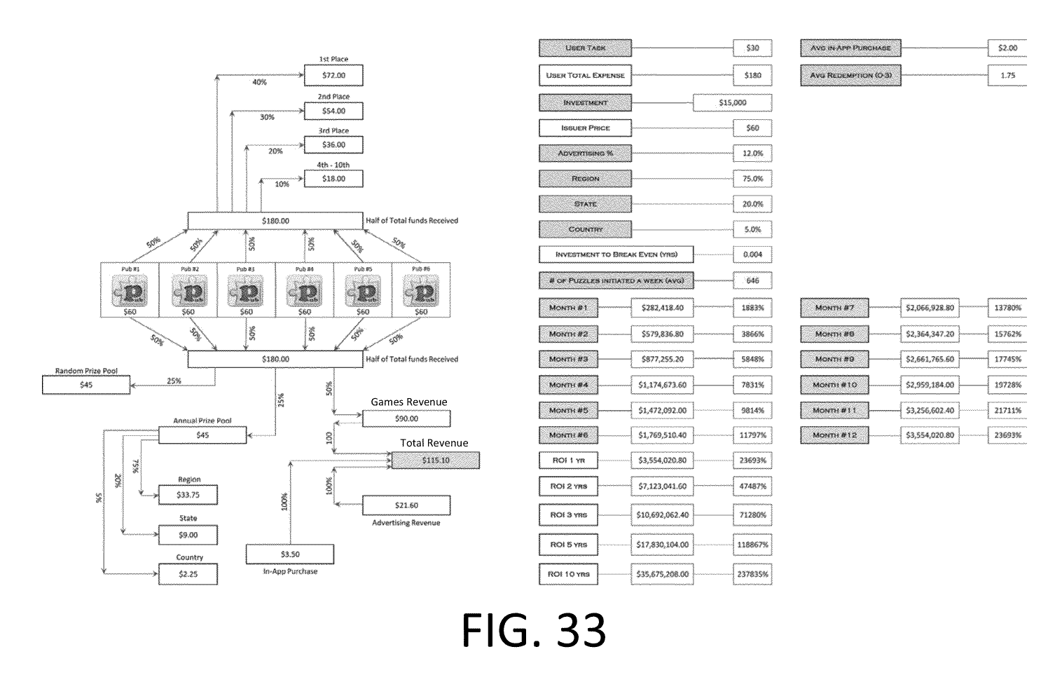

FIG. 33 is a block diagram showing aspects of an exemplary revenue distribution plan. A six piece puzzle is displayed in which each piece is provided by a unique puzzle piece provider entity (“PPPE”). Each PPPE purchases their piece ($60.00) based on, for example, twice the user task fee ($30.00) to participate in this puzzle. After all six PPPEs contribute funds, the entire prize pool stands at $360.00. Half of the total funds received ($180.00) are distributed to the first through third place finishers and to the drawing for the fourth through tenth place finishers. The remaining funds (half of the total funds received—$180.00) are allocated to the random prize pool, annual prize pools, and company revenue. Additional revenue created through in-app purchases and advertising are completely separate from the PPPE's prize pool and are directly related to the total company's revenue as a whole. Although 6 PPPE's, and a user fee of $30.00 are used in this example, those figures and values are not limiting: there may be more or fewer PPPE's; the user fee may be more or less than $30.00; more or less than half of the total funds received may be distributed to the finishers; there may be more or less than 10 finishers who receive awards; there may be different award ratios for the first, second, third, etc. finishers; the games revenue, advertising revenue and total revenue may be different; the return on investment (ROI) and the time required for a return on investment may be different; the allocations for advertising, etc., may be different. Other revenue generation models may also be appropriate, depending upon the particular environment, regulations, etc., and are contemplated herein.

It should be appreciated that the subject matter disclosed herein might be implemented as a computer-controlled apparatus, a computer process, a computing system, or as an article of manufacture such as a computer-readable storage medium. These and various other features will be apparent from a reading of the following Detailed Description and a review of the associated drawings.

Although the embodiments described herein have been described in language specific to computer structural features, methodological acts and by computer readable media, it is to be understood that the invention is not necessarily limited to the specific structures, acts or media described. Therefore, the specific structural features, acts and mediums are disclosed as exemplary embodiments implementing the invention disclosed herein.

The various embodiments described above are provided by way of illustration only and should not be construed to limit the invention. Also, unless the context or logic requires otherwise, the term “or” is used in its inclusive sense (i.e., at least one of the items listed, one or more of the items listed), not in its exclusive sense (one and only one of the items listed). Those skilled in the art will readily recognize various modifications and changes that may be made to the present invention without following the example embodiments and applications illustrated and described herein, and without departing from the true spirit and scope of the present invention.

1. A method of operating a server, the method comprising:
receiving a request from an electronic device for access by a user to a puzzle;
retrieving a profile for the user or preferences of the user;
retrieving conditions for access to the puzzle;
if the user is authorized to have access based to the puzzle based upon the profile or preferences of the user and the conditions for access then sending the puzzle to the electronic device for display to the user, the puzzle having a plurality of pieces, the display having an appearance, each piece having an appearance;
receiving a request from the electronic device to verify an input regarding a puzzle piece;
verifying validity of the input with respect to that puzzle piece;
if the input is valid with respect to that puzzle piece then causing the appearance of the display to be changed or causing the appearance of that puzzle piece to be changed; and
if inputs for a predetermined number of puzzle pieces have been verified or inputs for a predetermined set of puzzle pieces have been verified then instructing the electronic device to indicate that a goal has been reached or recording that a goal has been reached.

2. The method of claim 1 wherein the predetermined number of pieces is all of the pieces.

3. The method of claim 1 wherein instructing the electronic device to indicate that a goal has been reached comprises sending a verification code to the electronic device for display to the user.

4. The method of claim 1 wherein at least one of the pieces represents a task to be performed, the input is that the task has been performed, and verifying the validity of the input comprises comparing the input to a predetermined code or a predetermined entry.

5. The method of claim 1 wherein at least one of the pieces represents a task to be performed, the task is for the user to go to a specified location, the input is an identifier for the specified location, and verifying the validity of the input comprises comparing the identifier to a predetermined code or entry.

6. The method of claim 1 wherein causing the appearance of that puzzle piece to be changed comprises causing a color, transparency, opacity, shading, visual aspect, or physical attribute of that puzzle piece.

7. The method of claim 1 and, if inputs for a predetermined number of pieces have been verified or inputs for a predetermined set of puzzle pieces have been verified then sending another puzzle to the electronic device for display to the user, sending an instruction to the electronic device to present a display to the user with an option to begin another puzzle, or sending an instruction to the electronic device to present a display to the user with an option to select another puzzle.

8. The method of claim 1 and further comprising sending additional information to the electronic device for display to the user along with the puzzle, the additional information comprising news, a message, an advertisement, a location where a task for a piece may be performed, or a clue regarding a location where a task for a piece may be performed.

9. The method of claim 1 and further comprising, prior to sending a puzzle to the electronic device for display to the user, sending information regarding a plurality of authorized puzzles, along with an option to select one of the authorized puzzles, to the electronic device for display to the user.

10. The method of claim 1 and further comprising sending to the electronic device for display to the user, along with the puzzle, a list of locations where one or more tasks associated with the pieces of the puzzle may be performed.

11. The method of claim 1 and further comprising:
receiving from the electronic device an identification of a proximate second electronic device or an identification of a second user, the second user being associated with the second electronic device;
comparing at least some characteristics of the user profile to at least some corresponding characteristics of a profile of the second user; and
if a predetermined number of characteristics are matching or a predetermined set of characteristics are matching then sending to the electronic device an indication for display to the user that a match is present with respect to the second user.

12. The method of claim 1 and further comprising:
receiving from the electronic device an identification of a plurality of other electronic devices or an identification of a plurality of other users, each other user being associated with an electronic device of the plurality of other electronic devices, each other user having a corresponding other user profile;
comparing at least some characteristics of the user profile to at least some corresponding characteristics of each other user profile;
if a predetermined number of characteristics are matching or a predetermined set of characteristics are matching with respect to an other user, then recording that a match is present with respect to that other user; and
if at least a predetermined number of matches are present then recording that a team of users is present or transmitting a signal to the electronic device to display an indication that a team is present.

13. The method of claim 1 wherein the puzzle comprises at least one of a name, a picture, a map, a drawing, or a logo.

14. The method of claim 1 wherein at least one of the pieces represents a task to be performed, the task is for the user to go to a specified location and take a predetermined action, the input is an indication that the user took the predetermined action at the specified location.

15. The method of claim 1 wherein at least one of the pieces represents a task to be performed, the task is for the user to go to a specified location and take a predetermined action, the input is a code which indicates that the user took an action at a location, and verifying validity comprises inspecting the code to determine whether the action taken by the user is the predetermined action and whether the location where the user took the action is the specified location.

16. The method of claim 1 and, prior to sending the puzzle to the electronic device for display to the user, further comprising generating the puzzle by using one piece provided by a first entity and another piece provided by a second entity.

17. A method of operating a personal electronic device, the method comprising:
displaying a puzzle, the puzzle having a plurality of pieces, the display having an appearance, and each piece having an appearance;
accepting an input regarding a piece of the plurality of pieces;
verifying validity of the input with respect to that piece;
if the input is valid with respect to that piece then changing the appearance of the display or changing the appearance of that piece; and
if inputs for a predetermined number of pieces have been verified or inputs for a predetermined set of pieces have been verified then indicating that a goal has been reached, recording that a goal has been reached, transmitting a signal indicating that a goal has been reached, or displaying a reward.

18. The method of claim 17 wherein the predetermined number of pieces is all of the pieces.

19. The method of claim 17 wherein indicating that a goal has been reached comprises displaying a verification code.

20. The method of claim 17 wherein at least one of the pieces represents a task to be performed, the input is that the task has been performed, and verifying validity comprises sending a request to a server to confirm that the task has been performed.

21. The method of claim 17 wherein at least one of the pieces represents a task to be performed, the task is for a user to go to a specified location, and the input is an indication that the user is present at the specified location.

22. The method of claim 21 wherein accepting an input regarding a piece comprises receiving a code which is present at the specified location.

23. The method of claim 17 wherein at least one of the pieces represents a task to be performed, the task is for a user to go to a specified location and take a predetermined action, and the input is an indication that the user took the predetermined action at the specified location.

24. The method of claim 23 wherein accepting an input regarding a piece comprises receiving a code which indicates that the user took an action at a location and verifying validity comprises inspecting the code to determine whether the action taken by the user is the predetermined action and whether the location where the user took the action is the specified location.

25. The method of claim 17 wherein at least one of the pieces represents a task to be performed, the task is for a user to go to a specified location or take a predetermined action, the task is to be performed by one of a predetermined time or within a predetermined period of time, and the input is an indication that the user went to the specified location or took the predetermined action by the predetermined time or within the predetermined period of time.

26. The method of claim 17 wherein changing the appearance of that piece comprises changing a color, transparency, opacity, shading, visual aspect, or physical attribute.

27. The method of claim 17 and, if inputs for a predetermined number of pieces have been verified or inputs for a predetermined set of pieces have been verified then presenting a new puzzle, presenting a display with an option to begin another puzzle, or presenting a display with an option to select another puzzle.

28. The method of claim 17 wherein displaying a puzzle comprises presenting at least one piece provided by a first entity and at least one piece provided by a second entity.

29. The method of claim 17 and further comprising displaying, along with the puzzle, additional information, the additional information comprising news, a message, an advertisement, a location where a task for a piece may be performed, or a clue regarding a location where a task for a piece may be performed.

30. The method of claim 17 and further comprising, prior to displaying the puzzle, displaying information regarding a plurality of authorized puzzles along with an option to select one of the authorized puzzles.

31. The method of claim 17 and further comprising displaying a list of locations where one or more tasks associated with the pieces of the puzzle may be performed, accepting a selection of a location, and displaying address information for the selected location.

32. The method of claim 17 wherein:
the personal electronic device has at least one of a user profile stored thereon or remote access to a user profile;
accepting an input comprises accepting another user profile from a proximate personal electronic device or accepting an electronic link and obtaining the another user profile using the electronic link;
wherein the method further comprises:
comparing at least some characteristics of the user profile to at least some corresponding characteristics of the another user profile; and
if a predetermined number of characteristics are matching or a predetermined set of characteristics are matching then indicating that a match is present, recording that a match is present, or transmitting a signal indicating that a match is present.

33. The method of claim 17 wherein:
the personal electronic device has at least one of a user profile stored thereon or remote access to a user profile;
accepting an input comprises accepting another user profile from a proximate personal electronic device or accepting an electronic link and obtaining the another user profile using the electronic link;
wherein the method further comprises:
if at least one of a predetermined number of characteristics are matching or a predetermined set of characteristics are matching then indicating that a match is present, recording that a match is present, or transmitting a signal indicating that a match is present; and
if at least a predetermined number of matches are present then indicating that a team of users is present, recording that a team is present, or transmitting a signal indicating that a team is present.

34. The method of claim 17 and further comprising:
accepting a selection of a piece of the plurality of pieces, wherein the selected piece represents a task to be performed;
displaying an indication of the task;
wherein accepting an input comprises accepting an indication that the task has been performed; and
wherein verifying validity of the input comprises verifying that the task has been performed.

35. The method of claim 17 wherein the puzzle comprises at least one of a name, a picture, a map, a drawing, or a logo.
